(19) United States
(12) Patent Application Publication
(10) Pub. No.: US 2025/0102474 A1
(43) Pub. Date: Mar. 27, 2025

(54) ULTRASONIC SENSOR SYSTEMS FOR CHARACTERIZING LIQUIDS

(71) Applicant: Sartorius Stedim Biotech GmbH, Gottingen (DE)

(72) Inventors: Samin Akbari, Winchester, MA (US); David James Pollard, Stow, MA (US); Amin Ganjian, Toronto (CA); Phillip Anderson, Belmont, MA (US); Robert Balke, Winchester, MA (US)

(73) Assignee: Sartorius Stedim Biotech GmbH, Gottingen (DE)

(21) Appl. No.: 18/885,099

(22) Filed: Sep. 13, 2024

Related U.S. Application Data
(60) Provisional application No. 63/584,855, filed on Sep. 22, 2023.

(51) Int. Cl. G01N 29/44; G01N 29/02

(52) U.S. Cl. CPC G01N 29/4418; G01N 29/02; G01N 2291/022; G01N 2291/02466; G01N 2291/02809; G01N 2291/02818

(57) ABSTRACT

Systems and methods for characterizing a physical and solution properties of liquids are described. In some embodiments, an ultrasonic interrogation signal may be emitted into a liquid such as a solubilized protein solution. A resulting ultrasonic spectrum may be sensed and provided to a trained statistical model of the solution. The trained statistical model may then determine one or more properties of the liquid. In some embodiments, the trained statistical model determines a viscosity of the liquid and/or a solubilized protein concentration of the liquid. In some embodiments, a trained statistical classification model configured to classify the liquid based, for example, on its contents or properties is used to improve modeling accuracy.

### RELATED APPLICATIONS

This Application claims the benefit of priority under 35 U.S.C. §119(e) of U.S. Provisional Application Ser. No. 63/584,855, filed Sep. 22, 2023, entitled “ULTRASONIC SENSOR SYSTEMS FOR CHARACTERIZING LIQUIDS”, which is incorporated herein by reference in its entirety.

### FIELD

Disclosed embodiments are related to ultrasonic sensor systems, and related methods, for characterizing liquids.

### BACKGROUND

Ultrasonic sensors can be used to determine various parameters associated with liquids. Improved methods of interpreting ultrasonic signals are desired.

### SUMMARY

Systems and methods for characterizing a physical and solution properties of liquids are described. In some embodiments, an ultrasonic interrogation signal may be emitted into a liquid such as a solubilized protein solution. A resulting ultrasonic spectrum may be sensed and provided to a trained statistical model of the solution. The trained statistical model may then determine one or more properties of the liquid. In some embodiments, the trained statistical model determines a viscosity of the liquid and/or a solubilized protein concentration of the liquid. In some embodiments, a trained statistical classification model configured to classify the liquid based, for example, on its contents or properties is used to improve modeling accuracy.

In one aspect, a method for characterizing the viscosity of a liquid is provides. According to some embodiments, the method comprises: obtaining an ultrasonic spectrum of the liquid; providing the ultrasonic spectrum to a trained viscosity statistical model of the liquid; and determining the viscosity of the liquid using the trained viscosity statistical model.

In another aspect, a method for characterizing one or more properties of a solubilized protein solution is provided. According to some embodiments, the method comprises: obtaining an ultrasonic spectrum of the solubilized protein solution; providing the ultrasonic spectrum to a trained statistical model of the solution; and determining the one or more properties of solubilized protein solution using the trained statistical model.

In yet another aspect, a method for characterizing a liquid is provided. In some embodiments, the method comprises: obtaining an ultrasonic spectrum of the liquid; providing the ultrasonic spectrum to a first trained statistical classification model; and classifying the solution using the first trained statistical model to determine a class of the liquid from a plurality of classes.

In still another embodiment, a method for training a statistical model, the method comprising: obtaining training data, wherein the training data includes ultrasonic spectra for liquids and one or more properties of the liquids associated with the ultrasonic spectra, wherein the one or more properties of the liquid include viscosities of the liquids; generating a trained viscosity statistical model using the training data; and storing the trained viscosity statistical model for subsequent use.

In another aspect, a method for training a statistical model is provided. In some embodiments, the method comprises: obtaining training data, wherein the training data includes ultrasonic spectra for solubilized protein solutions and one or more properties of the solubilized protein solutions; generating a trained statistical model using the training data; and storing the trained statistical model for subsequent use.

In still another aspect, a method for training a statistical model is provided. In some embodiments, the method comprises: obtaining training data, wherein the training data includes ultrasonic spectra for a plurality of different liquids and classes of the different liquids; generating a trained statistical classification model using the training data, wherein the first trained statistical model is configured to classify an unknown liquid as one of the plurality of different liquids based, at least in part, on an ultrasonic spectrum of the unknown liquid; and storing the trained statistical classification model for subsequent use.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic diagram of one embodiment of a sensor system, according to some embodiments;

FIG. 2 is a schematic diagram of one embodiment of a sensor system, according to some embodiments;

FIG. 3 is a schematic perspective view of one embodiment of a well array, according to some embodiments;

FIG. 4A is a schematic cross-sectional diagram of a well array and transducer, according to some embodiments;

FIG. 4B is a schematic cross-sectional diagram of the transducer and well array of FIG. 4A in contact, according to some embodiments;

FIG. 5 is a schematic diagram of one embodiment of a method for training a statistical model, according to some embodiments;

FIG. 6 is a schematic diagram of one embodiment of a method for using a statistical model to determine properties of a liquid, according to some embodiments;

FIG. 7 is a schematic diagram of one embodiment of a method for using a statistical model to determine properties of a liquid, according to some embodiments;

FIG. 8 is a schematic diagram of one embodiment of a method for training a statistical model, according to some embodiments;

FIG. 9 is a schematic diagram of one embodiment of a method for using a statistical model to determine properties of a solubilized protein solution, according to some embodiments;

FIG. 10 is a schematic diagram of one embodiment of a method for using a statistical model to determine properties of a solubilized protein solution, according to some embodiments;

FIG. 11 is a schematic diagram of one embodiment of a method for training a statistical model, according to some embodiments;

FIG. 12 is a schematic diagram of one embodiment of a method for using a statistical model to determine properties of a liquid, according to some embodiments;

FIG. 13 is a schematic diagram of one embodiment of a method for using a statistical model to determine properties of a liquid, according to some embodiments;

FIGS. 14A-14B present training and validation data for a trained statistical model, according to some embodiments;

FIGS. 15A-15B present training and validation data for a trained statistical model, according to some embodiments;

FIGS. 16A-16B present training and validation data for a trained statistical model, according to some embodiments;

FIGS. 17A-17B present training and validation data for a trained statistical model, according to some embodiments;

FIGS. 18A-18B present training and validation data for a trained statistical model, according to some embodiments;

FIGS. 19A-19B present training and validation data for a trained statistical model, according to some embodiments;

FIGS. 20A-20B present training and validation data for a trained statistical model, according to some embodiments;

FIGS. 21A-21B present training and validation data for a trained statistical model, according to some embodiments;

FIG. 22 presents a comparison of the viscosity vs. concentration of various solubilized proteins, according to some embodiments;

FIGS. 23A-23B present training and validation data for a trained statistical model, according to some embodiments;

FIGS. 24A-24B present training and validation data for a trained statistical model, according to some embodiments; and

FIGS. 25A-25B present training and validation data for a trained statistical model, according to some embodiments.

### DETAILED DESCRIPTION

The determination of liquid properties and the identification of substituents of liquid solutions is an important technological area. Ultrasonic sensors may be used to identify properties of liquids, but ultrasonic measurements depend on multiple, mutually convoluted properties of a liquid, and are further complicated by simultaneous liquid processing steps like agitation or mixing. In view of these challenges, the Inventors have recognized the benefits associated with using a trained statistical model for determining one or more properties of a liquid using an ultrasonic transducer as detailed further below.

Viscosity is an important and highly sensitive processing parameter of a liquid—especially in the context of the preparation of pharmaceutical agents, where incorrect viscosity may render a drug unusable. For example, in some embodiments, minor fluctuations in the manufacturing of pharmaceutical agents can cause significant changes to viscosity (e.g., to the viscosity of a protein purified solubilized in a liquid solution) that can impact a manufacturing process and that can indicate the need for processing changes (e.g., to further dilute or concentrate a solute, change a temperature, vary processing times, or other appropriate changes to any desired process parameter). Under such circumstances, accurately determining the viscosity of the liquid (e.g., of a solubilized protein solution) may be desirable to properly monitor and control an associate process.

While determining viscosity of a liquid is desirable, doing so on an active process is difficult—particularly as part of an in-line process where viscosity measurement is affected by agitation or time-variation and/or typical sampling methods may complex and/or increase the risk of contaminating the materials being measured. In the context of the present disclosure, it has been recognized that one way to measure viscosity is through ultrasonic measurement of the liquid, as discussed in greater detail below. Thus, the Inventors have recognized that trained statistical models can be trained and used to accurately determine the viscosity of a solution in an in-line and/or other appropriate application, providing a significant improvement to the accuracy with which viscosity may be measured. In some embodiments, a statistical model is trained or used to determine a physical property of the liquid, such as viscosity, based at least in part on an ultrasonic spectrum of the liquid that is measured with a corresponding system configured to generate and measure an ultrasonic spectrum of the liquid. The trained viscosity statistical models provided herein may be suitable for determining the viscosity of any of a variety of suitable liquids, such as pure liquids, solutions (including but not limited to protein solutions) suspensions (e.g., suspensions of cells, cell fragments, or protein aggregates), and/or any other appropriate liquid capable of having its viscosity measured using ultrasonic spectra.

For many therapeutics, it is desirable to maintain a protein in a dispersed state within a liquid with little to no aggregation of the proteins, and with the correct viscosity. However, determining the concentration, or other properties of the liquid, may be complicated relative to methods previously used for characterizing liquids including particles such as aggregated proteins. Therefore, in some embodiments, trained statistical models as described herein may be used to simplify and enable the determination of the properties of solubilized protein solutions using ultrasonic spectra of the liquid. Solubilized protein solutions are an important class of pharmaceutical, with antiviral, vaccine, and other therapeutic applications. However, maintaining the proper viscosity, concentration, and solubility of the proteins in solutions can be an important part of maintaining a desire manufacturing process. Thus, during manufacturing, it may be advantageous to identify one or more properties of a solubilized protein solution, such as the concentration of the solubilized protein dissolved in the solubilized protein solution using an ultrasonic method. Ultrasonic measurement of solubilized protein concentrations may offer certain advantages over conventional techniques such as ultraviolet spectroscopy, including low noise and high accuracy concentration measurements for high concentration solubilized protein solutions. According to some embodiments, the disclosure provides a trained statistical model configured for determining one or more properties of a solubilized protein solution using an ultrasonic spectrum of the solubilized protein solution. For example, the trained statistical model may be configured to determine the concentration of the solubilized protein, according to some embodiments.

As used herein, a solubilized protein solution may refer to a solution that comprises a protein that is solubilized such that most of the protein is present in the form of a single oligomeric species. As a non-limiting, illustrative example, a solubilized protein solution could comprise a protein that is dissolved such that 95 wt % of the protein exists as a single dimerized species, while the remaining 5 wt % of the protein exists in the form of protein aggregates or protein monomers. In some embodiments, a solubilized protein solution is monodispersed, such that all the protein present in the solubilized protein solution exists in the form of a single oligomerized species. However, in some embodiments, a solubilized protein is not monodispersed. According to some embodiments, a solubilized protein solution may be solubilized such that greater than or equal to 90 wt %, greater than or equal to 95 wt %, greater than or equal to 98 wt %, greater than or equal to 99 wt %, greater than or equal to 99.5 wt %, or greater than or equal to 99.9 wt % of the solubilized protein present in the solubilized protein solution is in the form of a single oligomerized (e.g., monomerized, dimerized, trimerized, tetramerized) species dispersed in the solution. In some embodiments, the solubilized protein is uniformly dispersed in the solution.

Models of liquid properties typically have improved predictive power when they are trained on narrow classes of liquids similar to the liquids they will be used to model. This means that the use of a single statistical model to determine liquid properties of widely diverse liquids may have limited accuracy. Additionally, the Inventors have recognized that it may be desirable for an algorithm used to determine the properties of one or more of the liquids to be capable of automatically identifying and applying the correct one or more trained models to determine the properties of a liquid in some instances. Thus, the Inventors have recognized that it may be advantageous, in some embodiments, to initially classify liquids prior to modeling their properties, in order to use a trained statistical model that more accurately predicts the properties of liquids within a given identified class of liquids. In one aspect, therefore, the disclosure is directed towards methods of training and using statistical classification models to initially classify a liquid where the identified class of liquid may then be used to select one or more corresponding trained statistical models for use in determining one or more desired properties of the identified liquid.

In view of the above, the trained statistical classification models provided herein may be used to classify a liquid into any of a plurality of discrete classes. For example, in some embodiments, a trained statistical model is configured to classify a liquid into a class defined, at least in part, by one or more identifying properties of the liquid. Identifying properties of the liquid that could be used to classify the liquid include, but are not limited to: the identity of the liquid as a pure liquid, a solution (e.g., a solubilized protein solution), a suspension (e.g., a suspension of protein agglomerates, cells, and/or cell fragments); the identity of one or more solvents present in the liquid; the identify of a type of protein suspended within the liquid; and/or any other appropriate type of classification of liquid. For example, in some embodiments the trained statistical classification model is trained to classify a liquid based on the type of solubilized proteins in the liquid. Some of the identifying properties may be user-specified, if known. Thus, the trained classification statistical model may be configured to determine a class of a liquid from a plurality of potential classes of liquids using an ultrasonic spectrum and/or other appropriate types of input data.

As noted above, the determined class of a liquid may be used to select one or more trained statistical models that are trained for determining one or more properties of the identified liquid from a plurality of trained statistical models configured to determine the one or more properties for the different classes of liquid.

It should be understood that any appropriate type of statistical model may be used to determine a desired property of a liquid in any of the various embodiments disclosed herein. Appropriate types of statistical models may include, but are not limited to, a multivariant model, a neural network, a partial least squares regression model, a random forest regression model, a support vector machine regression, and/or any other appropriate type of statistical model of the liquid. In embodiments in which a multivariant model is used, a principal component analysis, partial least squares, orthogonal partial least squares, or other appropriate type of multivariant model may be used as the disclosure is not limited to the specific statistical model used with the embodiments disclosed herein. A trained statistical model suitable for determining a property of a liquid (e.g., of a solubilized protein solution or other liquid as described herein) may be any of the above-mentioned statistical models and/or any other appropriate statistical model capable of determining the desired one or more properties with the corresponding one or more types of data.

The liquids described herein may be classified using any of a variety of trained statistical models configured to classify a liquid in any of the corresponding embodiments disclosed herein. For example, a trained statistical classification model suitable for classifying a liquid may be of any of a variety of suitable types, including, but not limited to, principal component analysis (PCA), partial least squares discriminant analysis (PLS-DA), orthogonal projections to latent structures discriminant analysis (OPLS-DA), K-nearest neighbors (KNN), logistic regression, support vector machine classification (SVMC), random forest analysis, and neural network models. The trained statistical classification model may be trained to directly classify a liquid based, at least in part, on its ultrasonic spectrum. In some embodiments, the trained statistical classification model may be implemented using multiple models trained to classify a liquid by a multi-step process of determining one or more properties of the liquid (e.g., a viscosity of the liquid, a solubilized protein concentration of the liquid) and using one of the above-mentioned classification models to classify the liquid based on the one or more estimated properties. Where the trained statistical classification algorithm uses one or more property estimates of the liquid as an input, any of a variety of suitable techniques may be used to estimate the one or more properties of the liquid. For example, the trained statistical models disclosed herein may be used to determine the one or more liquid properties. Alternatively, in some embodiments the trained statistical classification model may simply use an ultrasonic spectrum as a direct input for determining the class of a liquid as the disclosure is not limited in this fashion.

The Inventors have recognized that using a single model trained over the entire potential range of a property of a liquid may provide less than a desired level of accuracy for determining a value of the property in some instances. Thus, the Inventors have recognized the benefits associated with using multiple trained statistical models that are trained over separate sub-portions of an expected range of values to predict liquid properties that can vary broadly over the expected ranges for the property. This may include properties such as the viscosity of a liquid, the concentration of a solute, the concentration and size of suspended particles and/or other appropriate parameter of the liquid that may be measured. Thus, in some aspects, the disclosure is directed towards use of a first trained statistical model to initially estimate one or more properties of a liquid. In some embodiments, the initial estimate of the one or more properties of the liquid may be used to select a second trained statistical model from a plurality of trained statistical models that are configured to determine the one or more properties on separate sub-portions of an expected range of values of the one or more properties. For example, the initial estimate of the one or more properties provided by the first trained statistical model may be used to bin the liquid into one of a plurality of bins defined by the values of the one or more properties. The plurality of bins may be associated with a plurality of trained second statistical models, e.g., so that once the initial estimate of the one or more properties has been used to place the liquid within a particular bin, one or more properties of the liquid may subsequently be determined using a second trained statistical model configured to determine the one or more properties for liquids associated with the particular bin. The second trained statistical model may then be used to determine one or more properties of the liquid. The second trained statistical model may be configured to determine either a more accurate value of the one or more properties determined by the first trained statistical model, or to determine a different one or more different properties. For example, the second trained statistical model may be configured to determine the same one or more properties estimated in the initial estimate of the first trained statistical model, but determined more accurately, or it may be used to determine an accurate estimate of a different property.

In one exemplary embodiment of the above, in some embodiments, a first trained statistical model is used to bin liquids based on an initial estimate of their viscosity or other property (e.g., to bin the liquid as having “low”, “medium,” or “high” viscosity where each bin of viscosity is associated with a different range of viscosity values). The initially estimated viscosity of the liquid may be used to select a second trained statistical model (e.g., a “low viscosity”, “medium viscosity”, or “high viscosity” model) that can determine the viscosity with a greater accuracy. As another example, in some embodiments a trained statistical model is configured to bin a solubilized protein solution based on an initial estimate provided by a first trained statistical model (e.g., to bin the liquid as including a “low”, “medium”, or “high” concentration of a solubilized protein) and the concentration bin of the solution may be used to select a second trained statistical model (e.g., a “low concentration”, “medium concentration”, or “high concentration” model) corresponding to the initial rough estimated concentration of the liquid which can then be used determine the concentration with greater accuracy.

As noted above, the first trained statistical model may be used to bin the liquid into any of a variety of suitable numbers of bins based on an initial estimate of one or more properties. In some embodiments, a trained statistical model bins a liquid into one of a plurality of bins comprising greater than or equal to 2 bins, greater than or equal to 3 bins, greater than or equal to 4 bins, greater than or equal to 5 bins, greater than or equal to 6 bins, greater than or equal to 7 bins, greater than or equal to 8 bins, or greater than or equal to 9 bins. In some embodiments, a trained statistical model is used to bin a liquid into one of a plurality of bins comprising less than or equal to 10 bins, less than or equal to 9 bins, less than or equal to 8 bins, less than or equal to 7 bins, less than or equal to 6 bins, less than or equal to 5 bins, less than or equal to 4 bins, or less than or equal to 3 bins. Combinations of these ranges are also possible (e.g., greater than or equal to 2 bins and less than or equal to 10 bins, or greater than or equal to 3 bins and less than or equal to 5 bins). Other ranges are also possible, as the disclosure is not so limited.

According to some, non-limiting embodiments, a trained statistical model, or algorithm implemented using an estimate of a value of the property, may bin a liquid into a bin corresponding to a range of property values based at least in part on the determined value of a liquid property, such as viscosity, solubilized protein concentration, particle size, particle concentration, or other appropriate parameter. For example, it may be advantageous, in some embodiments, to bin a liquid into one of exactly three bins defined by having a relatively “low”, “medium”, or “high” value of the property. Although it may be possible for bins to have overlapping boundaries, in some embodiments it is advantageous for the bins to have non-overlapping boundaries such that a liquid may unambiguously be assigned to exactly one bin. To provide a specific example, in some embodiments, a liquid may be binned as low viscosity if it has a viscosity between 1-2 cP, medium viscosity if it has a viscosity between 2-20 cP, and high viscosity if it has a viscosity greater than 20 cP. Of course, models could be trained such that viscosity could be binned within other combinations of viscosity ranges, as the disclosure is not so limited.

As noted above, the disclosed systems and methods may be used to characterize a number of different types of liquids. Due to the impacts of various physical parameters of a liquid and the physical construction of a system used to generate and measure an ultrasonic signal on a sensed ultrasonic spectrum, it may be desirable in some embodiments to train a model for the specific liquids, systems, and/or process parameters that may be present during a process to be monitored. This may include, for example, obtaining and using training data on a desired system, with the desired one or more liquids and with the expected constant or range of parameters associated with the process including, for example, vessel thickness and/or geometry of a container containing a liquid, liquid composition (e.g., solute identity, solvent identity, solute concentration, solvent concentration), particle composition, particle size, particle concentration, and/or any other appropriate physical parameter and/or design feature associated with the liquid and/or an ultrasonic sensor system. This calibration may include either initial training of a statistical model using the physical parameters that may be present during operation and/or updating a model with additional training data.

Trained statistical models and trained statistical classification models provided herein may be used to determine properties of any of a variety of suitable liquids. In some embodiments, the liquid is a pure liquid (e.g., pure water, pure ethanol, or pure glycerol). Of course, in some embodiments the liquid is a solution comprising at least one solvent (e.g., water, ethanol, or glycerol) and at least one solute dissolved in the solvent. Any of a variety of solutions may be modeled as described herein. For example, the solution may be a polymer solution such as a solubilized protein solution, a salt solution, or an acidic or basic solution. Non-limiting examples of solutions that may be used include solubilized protein solutions, cell culture media, buffer compositions, active pharmaceutical ingredient solutions, and combinations thereof. As discussed elsewhere herein, liquids that are solubilized protein solutions may be of particular interest, due to the difficulty of processing and measuring solubilized protein solution in-line, and due to their significant pharmaceutical importance. In some embodiments, the liquid is a suspension comprising a plurality of particles (e.g., cells, cell fragments and/or protein aggregates) suspended in the liquid. The liquid may be a pure liquid or may be a solution. For example, in some embodiments, a suspension of protein aggregates is formed in a solution comprising dissolved protein—the protein aggregates represent a portion of the protein in the suspension that has not dissolved. Thus, it should be understood that the methods and systems disclosed herein may be used to determine properties for any appropriate type of liquid.

Any of a variety of properties of a liquid may be determined using the methods provided herein. As discussed above, in some embodiments the viscosity of a liquid may be determined using a method provided herein. As another example, the solubilized protein concentration in a solubilized protein solution may be determined, according to some embodiments. In some embodiments, one or more properties of a plurality of particles (e.g., a plurality of cells or a plurality of protein aggregates) suspended in a solution may be determined. The properties of the plurality of particles suspended in a solution may include, but are not limited to, properties such as particle type, particle size (i.e., average maximum dimension of a particle), particle size distributions, concentrations of the particles, particle composition, particle stiffness, cell viability and/or any other appropriate parameter related to the particles suspended in the solution. In one embodiment, the property determined by a model may be a concentration of the particles in a solution. In another embodiment, the property may be a cell viability of cells suspended in the solution. In other embodiments, combinations of a concentration, cell viability, and/or any other appropriate parameter may be determined. In yet another embodiment, the particle composition may be determined. Depending on the applications this may also include determining the properties associated with mixtures including multiple populations of particles of different size and/or composition (i.e. determining properties for each particle population).

It should be understood that the various embodiments described herein may be used to determine any appropriate combination of one or more properties of a liquid. For example, in some embodiments, a statistical model is trained or used to determine more than one property of the liquid. As another example, in some embodiments a trained statistical model is trained to determine exactly one property of a liquid. Any of a variety of properties may be determined by such a method.

In some aspects, one or more trained statistical models or trained statistical classification models are provided. A trained statistical model or trained statistical classification model may be trained using any of a variety of appropriate methods. For example, training data may be obtained for training the statistical model or statistical classification model. The training data may include ultrasonic spectra. In some embodiments, the ultrasonic spectra may be substantially unprocessed, which may refer to the ultrasonic spectra, where were measured in the time domain, still being in the time domain without having been transformed to another domain, such as the frequency domain. The ultrasonic spectra may be measured for different liquids (e.g., pure liquids, solutions, and/or suspensions) where the one or more operating parameters to be measured may be varied between the different liquids to provide a desired range of training data. The training data may also include corresponding properties and/or classes of the liquid that are associated with each of the ultrasonic spectra. These properties and/or classes may include, but are not limited to, viscosity, solute concentration (e.g., protein concentration in a solubilized protein solution), solute identity (e.g., protein identity in a solubilized protein solution), particle type, particle size (i.e., average maximum dimension of a particle), particle size distributions, concentrations of the particles, particle composition, particle stiffness, cell viability, and/or any other appropriate parameter discussed herein. Regardless of the specific training data, the training data may be used to generate a trained statistical model including, for example, a trained multivariant model by inputting the training data into an appropriate analysis module.

In order to provide the desired training data, ultrasonic spectra for liquids (e.g., pure liquids, solutions, or suspensions) with different properties of interest (e.g., viscosity, protein concentration, particle size, particle concentration, etc.) or classes of interest (e.g., solvent identity, solute identity, liquid type) may be conducted to obtain a desired number of training data points. Alternatively, in some embodiments, the training data may be obtained from data available from prior experiments and/or calculations. This training data may be input into a statistical model and/or a statistical classification model as elaborated on herein. In some embodiments, an appropriate number of data points may be as verification data to determine an accuracy of the model. Depending on the particular embodiment, the trained statistical model may any of the statistical models discussed above (e.g., a multivariant model). In one such embodiment, the multivariant model may be a multivariant model of the liquid. Depending on the particular embodiment, a trained statistical classification model may be any of the trained statistical classification models discussed above. However, regardless of the specific statistical model and/or the statistical classification model used, providing the training data to an appropriate statistical model analysis module may result in the desired trained statistical model and/or the statistical classification model being output. For example, once a trained statistical model and/or a trained statistical classification model has been generated using the one or more desired properties or liquid class and the corresponding ultrasonic spectra, the trained statistical model and/or the trained statistical classification model may be stored for subsequent use. For instance, the trained statistical model and/or the trained statistical classification model may be stored on at least one non-transitory processor readable memory. The stored model(s) may then be used for a number of different applications related to determining the properties and/or classes of liquids as detailed herein.

As noted above, the Inventors have recognized that large variations in physical properties (e.g., temperature, viscosity), solution properties (e.g., solute concentration), and/or particle properties may affect the ability of a trained statistical model to accurately predict a desired property of a liquid. In some embodiments, a first statistical model of a liquid is trained using training data with one or more properties that vary over a wide range. According to some embodiments, subsets of the training data used to train the first statistical model are binned based on the value(s) of the one or more widely-varying properties and used to train a plurality of second trained statistical models over different sub-portions of the overall range of the one or more properties. Thus, the second trained statistical models may exhibit improved accuracy over the corresponding smaller sub-ranges of the one or more properties relative to the accuracy of the first trained statistical model trained on the full set of training data which extends over the entire range of the expected one or more properties. Of course, the first trained statistical model and the plurality of second trained statistical models may, in some embodiments, be trained using different or overlapping training data sets, as the disclosure is not so limited.

As also noted above, the Inventors have recognized that liquids belonging to different classes may be difficult to predict accurately using a single statistical model. Accordingly, in some embodiments, a statistical classification model of a liquid is trained using training data belonging to more than one class (e.g., the class of a liquid, such as a solubilized protein, and the corresponding ultrasonic spectra). The training data used to train the trained statistical classification model may then be separated by class, and subsets of the training data belonging to the various classes identifiable to the trained statistical classification model may be used to train one or more statistical models capable of determining one or more properties of the liquids within each class as detailed above (e.g., training a model using the desired one or more properties and ultrasonic spectra to train separate models for the separate classes of liquids).

The training data may be used to train the statistical model and/or the statistical classification models noted above using any of a variety of different training methods. This may include, for example, training the models using supervised, partially supervised, and/or unsupervised training modules.

The high degree of temperature control provided in many commercial manufacturing systems means that, under many circumstances, the models provided herein need not be trained using temperature data due to the temperature being relatively constant during a process. However, temperature can have a significant impact on certain types of measurements—both by affecting ultrasonic measurements of the liquid (e.g., through temperature-driven changes in fluid properties that affect ultrasound transmission) or by directly affecting a property of the liquid (e.g., by changing the viscosity of the liquid, which typically has a significant temperature dependence). Therefore, in some embodiments the training data may also include variations in temperature data used to train the models. For example, training data may include measurements of the desired parameter, the ultrasonic spectrum, and the temperature of a liquid. Thus, in some embodiments (e.g., where temperature of the liquid may be readily obtained) a trained statistical model may be trained using temperature data, and may be used to determine one or more properties of the liquid based, at least in part, on the temperature data in addition to the ultrasonic spectrum.

It should, of course, be understood that the use of temperature data in training data is optional, and is not required in all embodiments. For example, in some embodiments a model trained without temperature variation may remain accurate as the temperature is varied around the temperature at which the training data were collected within a desired range of temperatures. One advantage of the models provided herein is that, in some embodiments, they may accurately predict changes in properties (e.g., viscosity) that are temperature dependent, even when they are not trained using temperature data. Temperature training data may be measured using any of a variety of appropriate sensors known to those of ordinary skill in the art, including but not limited to: a thermocouple, a thermistor, or a pyrometer. Temperature training data may be measured directly, or may be measured indirectly through another medium, as the disclosure is not so limited.

In one embodiment, a method for characterizing a liquid (e.g., a pure liquid, a solution, or a suspension) may include obtaining an ultrasonic spectrum of the liquid. An ultrasonic spectrum of the liquid may be obtained either by measuring an ultrasonic signal emitted into the liquid, or recalling a previously measured ultrasonic spectrum. Regardless, the ultrasonic spectra may be provided to a trained statistical model and/or trained statistical classification model as discussed above.

The ultrasonic sensors and methods disclosed herein have multiple benefits relative to typical ultrasonic sensors used to characterize liquids (e.g., pure liquids, solutions, or suspensions). For example, in some embodiments, the systems and methods disclosed herein may be implemented without changing and/or interrupting a process. For instance, rather than stopping the agitation of a liquid to perform measurements on a quiescent liquid, the currently disclosed systems and methods may be implemented to measure one or more properties of a liquid during agitation of the liquid. The currently disclosed systems and methods may also be more flexible, more accurate, faster, and easier to calibrate for changes in the liquids being monitored. For example, in some embodiments, the use of measured ultrasonic spectra to determine the properties of a liquid may save on computational costs relative to systems and processes that may need to preprocess the spectra using one or more transformations and/or multiple analyzes to determine the desired properties. The use of the disclosed methods and system may thus result in faster computational times due to the reduced computational complexity. The disclosed systems and methods may also be relatively non-invasive on a liquid being monitored, and in some embodiments, may be performed without the need for dyes, electrodes, special coatings, or other materials being introduced into or coming into contact with the liquid as may occur with other types of monitoring technologies. At least partially because the method is non-invasive, in some embodiments the disclosed systems and methods may be particularly advantageous for use in continuous, in-line processes. In some embodiments, for example, ultrasonic spectra may be obtained as part of a real-time, continuous monitoring process. Correspondingly, in some embodiments one or more properties predicted by a trained statistical model provided herein may be obtained as part of a real-time, continuous or semi-continuous process where the desired one or more properties may be measured without interrupting or interfering with a process being performed within a volume being monitored according to some embodiments.

In the various embodiments described herein obtaining an ultrasonic spectrum may refer to any appropriate method of obtaining an ultrasonic spectrum. For example, in one embodiment, this may include emitting an ultrasonic interrogation signal into a liquid (e.g., a pure liquid, a solution, or a suspension). An appropriate transducer, or other sensor, may then be used to sense the resulting ultrasonic spectrum which may then be transmitted to either a processor integrated with the system and/or a computing device remotely located from the system. Alternatively, in some embodiments, obtaining an ultrasonic spectrum may include recalling from non-transitory computer readable memory a previously recorded ultrasonic spectrum. Accordingly, it should be understood that any method for obtaining the ultrasonic signals used with any of the methods and/or systems described herein as the disclosure is not limited in this fashion.

The viscosity of liquids having any of a variety of suitable viscosities may be determined using any embodiment of the method and systems disclosed herein. In some embodiments, a method and/or system provided herein may be used to determine the viscosity of a liquid having a viscosity greater than or equal to 0.5 cP, greater than or equal to 1 cP, greater than or equal to 2 cP, greater than or equal to 5 cP, greater than or equal to 10 cP, greater than or equal to 15 cP, greater than or equal to 20 cP, greater than or equal to 25 cP, greater than or equal to 30 cP, greater than or equal to 35 cP, greater than or equal to 40 cP, greater than or equal to 45 cP, greater than or equal to 50 cP, or greater than or equal to 55 cP. In some embodiments, a method and/or system provided herein may be used to determine the viscosity of a liquid having a viscosity less than or equal to 60 cP, less than or equal to 55 cP, less than or equal to 50 cP, less than or equal to 45 cP, less than or equal to 40 cP, less than or equal to 35 cP, less than or equal to 30 cP, less than or equal to 25 cP, less than or equal to 20 cP, less than or equal to 15 cP, less than or equal to 10 cP, less than or equal to 5 cP, or less than or equal to 2 cP. Combinations of these ranges are also possible (e.g., greater than or equal to 0.5 cP and less than or equal to 60 cP, greater than or equal to 1 cP and less than or equal to 2 cP, greater than or equal to 2 cP and less than or equal to 20 cP, or greater than or equal to 20 cP and less than or equal to 50 cP). Other ranges are also possible as the disclosure is not limited in this fashion.

Any of a varieties of protein concentrations of a solubilized protein solution may be determined using any embodiment of the method and systems disclosed herein. In some embodiments, a method and/or system provided herein may be used to determine the protein concentration of a solubilized protein solution having a protein concentration of greater than or equal to 0 g/L, greater than or equal to 1 g/L, greater than or equal to 50 g/L, greater than or equal to 100 g/L, greater than or equal to 150 g/L, greater than or equal to 200 g/L, greater than or equal to 250 g/L, greater than or equal to 300 g/L, greater than or equal to 350 g/L, greater than or equal to 400 g/L, or greater than or equal to 450 g/L. In some embodiments, a method and/or system provided herein may be used to determine the protein concentration of a solubilized protein solution having a protein concentration of less than or equal to 500 g/L, less than or equal to 450 g/L, less than or equal to 400 g/L, less than or equal to 350 g/L, less than or equal to 300 g/L, less than or equal to 250 g/L, less than or equal to 200 g/L, less than or equal to 150 g/L, less than or equal to 100 g/L, or less than or equal to 50 g/L. Combinations of these ranges are also possible (e.g., greater than or equal to 0 g/L and less than or equal to 500 g/L, greater than or equal to 1 g/L and less than or equal to 400 g/L, or greater than or equal to 1 g/L and less than or equal to 150 g/L). Other ranges are also possible as the disclosure is not limited in this fashion.

Particles evaluated using the methods and systems disclosed herein may have any of a variety of appropriate size range including sizes ranges (i.e. an average maximum transverse dimension) that are greater than or equal to 1 nm, 100 nm, 200 nm, 500 nm, 1 μm, 100 μm, 200 μm, 500 μm, and/or any other appropriate size range. Correspondingly, the size range may be less than or equal to 1000 μm, 500 μm, 200 μm, 100 μm, 500 nm, 200 nm, and/or any other appropriate size range. Combinations of the foregoing are contemplated including, for example, size ranges that are between or equal to 1 nm and 1000 μm, 500 nm and 500 μm, 500 nm and 100 μm, and/or any other appropriate size range as the disclosure is not limited in this fashion.

The suspensions used with the systems and methods disclosed herein may exhibit any of a variety of appropriate concentration ranges. For example, in some embodiments, a concentration range of particles in a suspension may be greater than or equal to 10³, 10⁴, 10⁵, 10⁶, 10⁷, or 10⁸ particles per milliliter (mL). Correspondingly the concentration range of particles in the suspension may be less than or equal to 10⁹, 10⁸, 10⁷, 10⁶, 10⁵, or 10⁴ particles per mL. Combinations of the foregoing are contemplated including, for example, concentrations in the range of 10⁴ to 10⁹ particles per mL though other concentrations are also contemplated as the disclosure is not limited in this fashion.

The ultrasonic transducers disclosed herein may be operated using any of a variety of appropriate frequency ranges for a desired application. That said, in some applications, a frequency range of an ultrasonic transducer used with the embodiments described herein may have an operating frequency that is greater than or equal to 1 MHz, 5 MHz, 10 MHz, 15 MHz, 20 MHz, and/or any other appropriate frequency range. The operating frequency may also be less than or equal to 30 MHz, 25 MHz, 20 MHz, and/or any other appropriate frequency range. Combinations of the foregoing ranges are contemplated including an operating frequency of an ultrasonic transducer that is between or equal to 10 MHz and 30 MHz. Of course, systems that operate in frequency ranges both greater than and less than those noted above are also contemplated as the disclosure is not limited in this fashion.

The training data may be obtained in any appropriate fashion using experiments and/or calculations. Due to the difficulty in experimentally determining this training data, the training data may be limited to a predetermined number of data points. Depending on the expected variations and complexity associated with a liquid to be measured, either a larger or smaller number of data points may be needed to train the desired statistical model. For example, the number of training data points may be greater than or equal to 20 data points, 50 data points, 100 data points, 500 data points, or other appropriate number of data points. Correspondingly, the number of training data points may be less than or equal to 2000 data points, 1000 data points, 500 data points, and/or any other appropriate number of data points. Combinations of the foregoing are contemplated including, a number of training data points that is between or equal to 20 data points and 100 data points, 20 data points and 2000 data points, and/or any other number of data points both greater than and less than the ranges noted above as the disclosure is not so limited. Regardless of the specific number, these training data points may be randomly selected throughout the desired range space of liquid properties, evenly distributed throughout the range space, and/or any other appropriate disposition as the disclosure is not limited in this fashion.

In instances in which an ultrasonic sensor system includes a housing and/or other material that a transducer may transmit and/or receive an ultrasonic sensor through, it may be desirable for the housing, or other structural feature, to be made from a material with sufficient acoustic transparency to permit a signal with a desired signal strength to be transmitted and sensed through the material. This may include considerations such as selecting a material with relatively small acoustic losses in the desired operating frequency ranges as well as appropriately small thicknesses between the transducer and liquid being characterized. Appropriate materials may include, but are not limited to, polymeric materials such as polycarbonate, polypropylene, polydimethylsiloxane (PDMS), polymethyl methacrylate (PMMA), glass, polyvinyl alcohol, polyvinyl acetate, polyethylene, and/or any other appropriate material as the disclosure is not limited to what materials a housing or other structure used to contain a liquid is made from. Additionally, in instances where material is disposed between the transducer and the liquid, the material may have a thickness that is between or equal to about 0.2 mm and 5 mm, and more preferably between or equal to about 1 mm and 3 mm, though thicknesses both greater than and less than these ranges are possible. In embodiments in which a housing or other structure with thicknesses greater than those noted above are used, the transducer may be received in a portion of the housing or other structure with a reduced thickness. For example, the transducer may be received in a blind hole sized and shaped to receive the transducer to place a transmitting end of the transducer in a desired position and orientation relative to an associated volume containing the liquid. One such embodiment is elaborated on further below. In view of the above, it should be understood that the currently disclosed systems and methods should not be limited to any particular material and/or housing construction as the disclosure is not limited in this fashion. Additionally, in some embodiments, a separate housing may not be used. Instead, in such an embodiment, an ultrasonic transducer may be placed in contact with a container (such as a flexible bag or other container) that the liquid is contained in without the use of a separate housing or structure associated with the ultrasonic sensing system. The ultrasonic transducer may then transmit an interrogation signal and sense the resulting ultrasonic spectrum through the container the liquid is disposed in.

As used herein, an ultrasonic transducer may refer to an integrated transducer that is configured to both transmit an ultrasonic interrogation signal, i.e. a plurality of ultrasonic pulses with a desired waveform, as well as sense the resulting ultrasonic spectrum, including both reflected and backscattered ultrasonic signals, produced in response to the ultrasonic interrogation signal propagating through the physical structures of the system and the liquid. Additionally, it should be understood that an ultrasonic transducer may refer to a system in which a separate ultrasonic transmitter and ultrasonic receiver are used to separately transmit the ultrasonic interrogation signal and sense the resulting ultrasonic spectrum respectively. Accordingly, it should be understood that the current disclosure is not limited to any specific construction of an ultrasonic transducer as the disclosure is not limited in this fashion.

For the sake of clarity, the majority of the embodiments described below in relation to the figures are directed to systems in which a liquid therein is disposed in an interior volume of a housing. For example, similar arrangements may be present in applications such as reactors including, but not limited to, bioreactors. However, the current disclosure should not be limited to only being used with systems in which a liquid is disposed within an interior volume of a housing. In one such embodiment, an ultrasonic transducer is placed into acoustic contact with a bag including a liquid disposed therein. Appropriate constraints to help ensure a repeatable arrangement of the ultrasonic transducer, relative spacing and arrangement of opposing sides of the bag, and/or other appropriate considerations for an ultrasonic measurement on a liquid contained within a bag may be provided. Such a measurement system may be advantageous for use in applications where components are routinely reacted or grown in bags, including, but not limited to, cell culturing within bags. Accordingly, it should be understood that any appropriate construction capable of appropriately positioning and orienting a transducer towards a liquid in a repeatable fashion for taking the desired ultrasonic measurements may be used as the disclosure is not limited to any particular physical construction.

In addition to the specific examples described below, it should be understood that the methods and systems disclosed herein may be used for any number of different applications including, but not limited to: non-invasive viscosity measurements of pure liquids, solutions, or suspensions; non-invasive measurements of solubilized protein concentration in solubilized protein solutions; non-invasive concentration measurements of nanoparticles, viruses, exosomes, and other particles; characterization of viruses inline with bioprocessing; characterization of exosomes; characterization of nanoparticles; characterization of particles during formulation and final drug product inspection; detection and/or characterization of bacterial and/or yeast contamination within a cell culture; detection and/or characterization of circulating tumors or different cell types for advanced therapies; and/or any other desired application where it may be desirable to detect the presence and/or characterize one or more properties of a pure liquid, a solution, or a suspension. Additionally, the methods and systems may either be provided as a standalone sensing system and/or they may be integrated into a system including a volume configured to contain a liquid to be characterized. For instance, the disclosed sensing systems may be integrated a bioreactor. In another embodiment, a system may be configured to characterize volumes included in separate multiwell plates, tissue culture flasks, and/or other structures used to contain a liquid. Accordingly, it should be understood that the disclosed methods and systems may be implemented in any number of different manners and should not be limited to just the currently disclosed embodiments.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

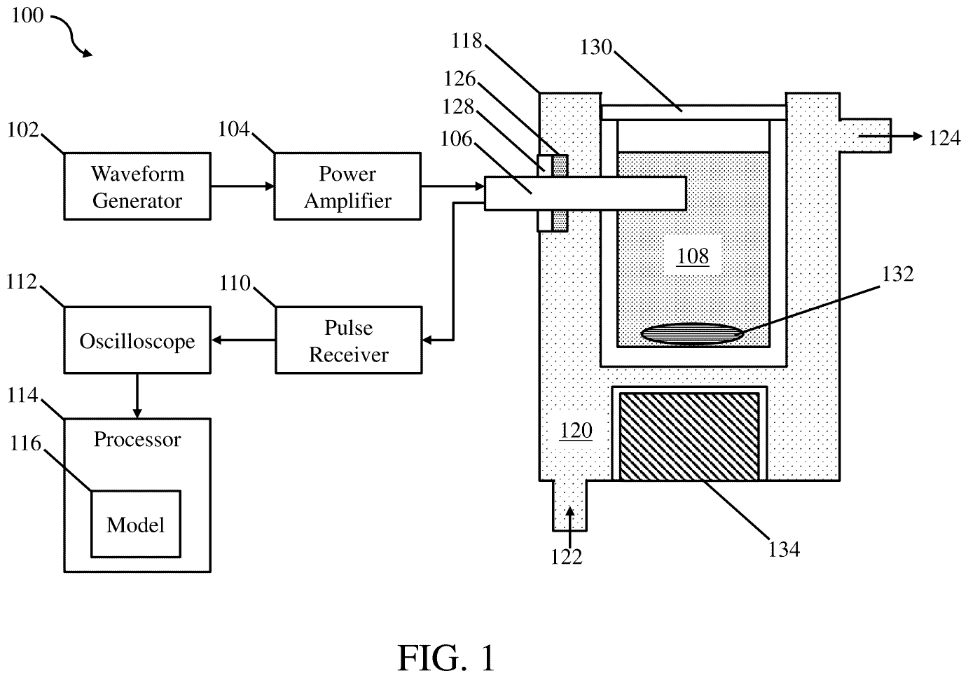

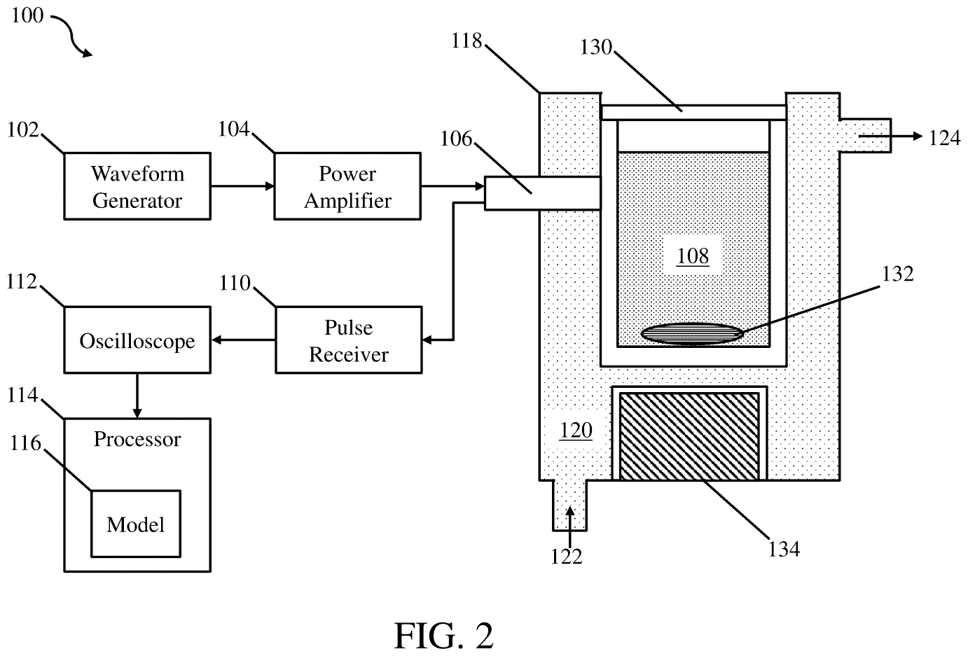

FIGS. 1 and 2 depict two similar embodiments of a sensor system 100. The depicted systems include a wave form generator 102 that may generate a desired ultrasonic waveform for transmission to an associated ultrasonic transducer 106 that is operatively coupled to the waveform generator. In some embodiments, an optional power amplifier 104, may be used to amplify a power of the waveform transmitted from the waveform generator to the ultrasonic transducer. In the depicted embodiment, the ultrasonic transducer is an ultrasonic transceiver that is configured to both transmit and sense ultrasonic signals. However, embodiments in which an ultrasonic transducer corresponding to a separate ultrasonic transmitter and corresponding ultrasonic receiver are used are also contemplated as the disclosure is not limited in this fashion. In either case, the sensed ultrasonic spectrum may be received by the pulse receiver 110. Depending on the particular implementation, the sensed ultrasonic spectrum may be output to an oscilloscope 112 which may then provide the ultrasonic spectrum to an operatively coupled processor 114. Alternatively, the measured ultrasonic signal may be provided directly to the processor depending on the particular application. In either case, the processor may be associated with non-transitory processor readable memory that includes an appropriate trained statistical model 116 stored thereon. The associated memory may also include processor executable instructions that when executed cause the processor to perform any of the methods disclosed herein.

While a processor associated with the oscilloscope has been illustrated in the figures, it should be understood that the depicted processor may be operatively coupled with any of the depicted components to generate the desired ultrasonic interrogation signal, sense the resulting ultrasonic spectrum, and perform the subsequent processing described herein as the disclosure is not so limited. Additionally, while a single processor has been depicted, it should be understood that any number of processors associated with any appropriate combination of the depicted components may be used. Further, these one or more processors may either be provided within a single integrated system and/or they may be provided separately as may be the case in which a separate attached or remotely located computing device including the processor is connected to the system.

The sensor system may also include a housing 118 that includes an internal volume configured to contain a liquid 108 disposed therein. In some embodiments, the ultrasonic transducer 106 may extend into the liquid as shown in FIG. 1. While the system shown in FIG. 1 is horizontal, embodiments in which a dipstick like configuration where the transducer is inserted into the liquid in an at least partially vertical orientation relative to a local direction of gravity are also contemplated. In instances where the transducer extends through a wall of the housing, it may be desirable to provide a seal between the transducer and the housing. For example, as shown in FIG. 1, an O-ring 126 may be disposed in a counter bored hole 128 aligned with the through hole extending through the housing that the ultrasonic transducer is disposed in. Alternatively, embodiments in which an ultrasonic transducer does not extend into the liquid are also possible. One such embodiment is shown in FIG. 2 where the ultrasonic transducer is disposed against a portion of the housing that is physically coupled with the liquid disposed within the internal volume of the housing through a portion of the housing disposed between the transducer and liquid. In the depicted embodiment, this corresponds to a blind hole oriented towards the liquid that the transducer is disposed in such that the transducer is oriented towards the interior volume and liquid contained therein, though other constructions may also be used. Regardless of the specific construction, the portion of the housing, or other structure, disposed between the transducer and liquid may have a known thickness and material type such that the acoustic properties of the housing may be taken into account when transmitting and sensing ultrasonic signals. In either case, the transducer may be oriented towards the liquid contained with the interior volume such that the transducer may transmit the desired ultrasonic waveforms into the liquid and measure the resulting ultrasonic spectrum. In some embodiments, the system is configured such that the interior volume is in-line for a manufacturing process, such that liquid may continuously flow through the interior volume as part of a continuous manufacturing process. For example, the interior volume could be the interior volume of a flow line, a tube, or any of a variety of other interior volumes suitable for measuring process parameters in-line for a continuous process.

In some embodiments, it may be desirable to either agitate and/or seal a liquid relative to an exterior environment during operation. For example, in some embodiments, a sensor system may be integrated into a bioreactor or other type of reactor where the liquid may be agitated to help provide a uniform dispersion of solutes, particles (e.g. cells), and/or other materials present within the liquid during normal operation. Accordingly, in some embodiments, the system may include any appropriate type of mixer including the depicted stir bar 132 and corresponding stir bar actuator 134 disposed on an opposing side of an intervening portion of the housing. Other appropriate types of mixers may include, but are not limited to, a shaker table, actuated mechanical mixers immersed in the liquid (magnet stirring rods, impellers, etc.), and/or any other appropriate type of mixer capable of agitating the liquid within the housing as the disclosure is not so limited. In some embodiments, and as depicted in the figures, the interior volume corresponding to the depicted liquid 108 disposed within the housing 118 may also be sealed from the exterior environment using a cover 130 and/or any other appropriate type of sealed construction as the disclosure is not limited to the particular type of housing and/or container that the sensor system is integrated in. However, embodiments in which the liquid is not sealed relative to an exterior environment are also contemplated.

It may be desirable to control a temperature of a liquid 108 either during operation and/or measurement of an ultrasonic signal. Accordingly, in some embodiments, a temperature regulation system such as the depicted water jacket 120 may be used. In the depicted embodiment shown in both FIGS. 1 and 2, the water jacket includes an inlet 122 that a liquid, such as water, flows into prior to flowing around the internal volume contained within the housing 118 to a corresponding outlet 124. As the liquid flows through the water jacket, heat may be exchanged with the liquid contained within the internal volume of the housing to either heat or cool the liquid depending on the specific application. It should be understood that other appropriate methods of controlling the temperature of a liquid may also be used including, but not limited to, immersion heaters, immersion coolers, actively controlled coolers and/or heaters integrated within the housing (e.g. resistive heaters, thermoelectric materials, etc.), and/or any other appropriate type of temperature control may be used.

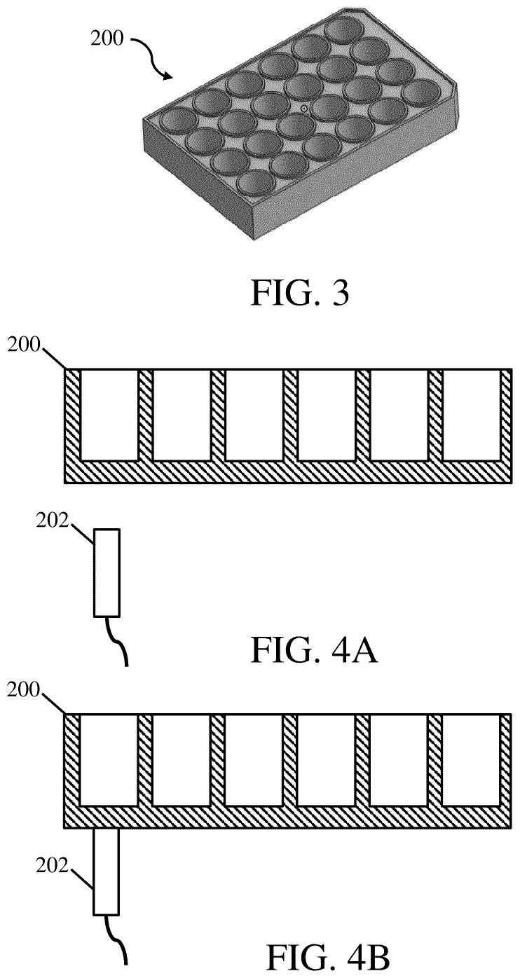

While FIGS. 1 and 2 depict the use of a sensor system with a single volume contained within the housing, it should be understood that the current disclosure is not limited to implementations with a single volume of a liquid. For example, FIG. 3 depicts one embodiment of a well array plate 200 such as may be used in a cell culture plate or other appropriate application. In many instances, it may be desirable to measure the parameters associated with the liquid contained within the individual wells of the depicted well array. Accordingly, in some embodiments, one or more ultrasonic transducers 202 may either be moved into contact, and/or may be integrated with, the individual portions of the plate associated with the separate wells of the well array plate 200, see FIGS. 4A and 4B. This may allow the individual interrogation of the liquids contained in the different wells using the ultrasonic transducer. The portions of the well plate that the ultrasonic transducer is placed into contact with may be made from an appropriate material and may have a desired predetermined thickness suitable for conducting the types of measurements described herein. In instances where either a single ultrasonic transducer, or multiple transducers that are less than a total number of wells and the plate, are used, either the well plate and/or the one or more ultrasonic transducers may be associated with an appropriate movement stage or robotic arm for moving into and out of contact with one another to permit the different wells of the plate to be measured sequentially, sec FIGS. 4A and 4B. In other instances, an equal number of ultrasonic transducers and wells may be used to permit the simultaneous measurement of the different wells.

In view of the above, it should be understood that the currently disclosed systems and methods may be incorporated into any appropriate system where it is desirable to measure the properties associated with a liquid.

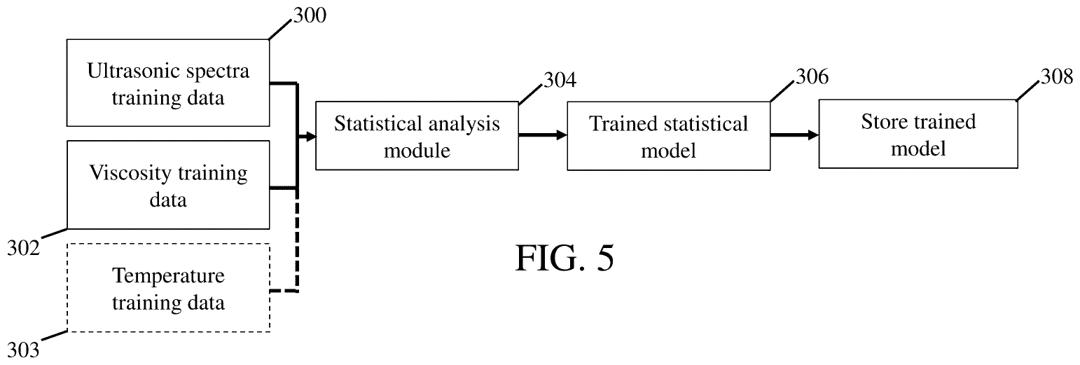

FIGS. 5-13 depict embodiments related to methods for training and using statistical models for use with the disclosed ultrasonic systems.

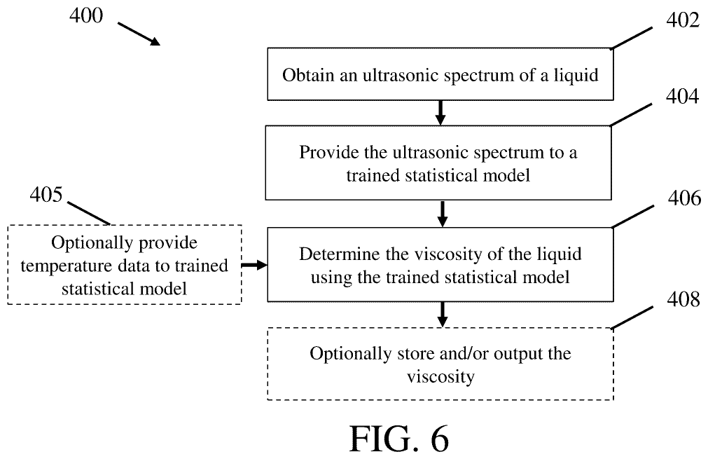

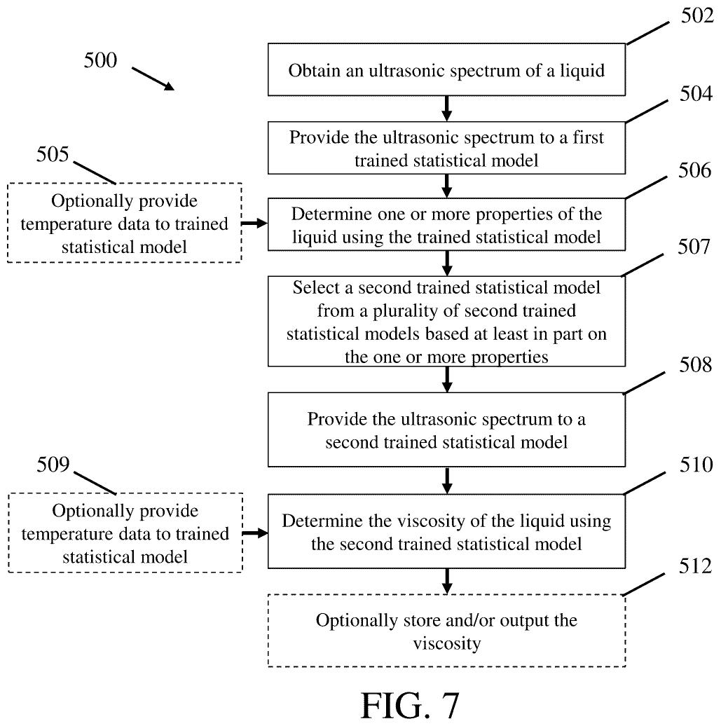

FIG. 5 provides a non-limiting example of training a statistical model for determining the viscosity of a liquid. Such a model, once trained, can be used to determine the viscosity of a liquid as discussed in greater detail with reference to FIGS. 6-7 below. The trained statistical model may thus be used in a variety of applications, such as in in-line viscosity detection systems. Thus, one or more operations of a system in which the liquid is disposed may be controlled based at least in part on the viscosity determined by the system.

In FIG. 5, training data may be input into an analysis module, such as the depicted statistical analysis module 304. In some embodiments, the training data may correspond to measured ultrasonic spectra training data 300 as disclosed herein. For example, in one embodiment, the ultrasonic spectra may correspond to unprocessed ultrasonic spectra that are in the original time domain they were measured in. The measured spectra may include a single ultrasonic interrogation signal and corresponding response signal. The response signal may include both reflected and backscattered ultrasonic signals including a wall response signal corresponding to the interrogation signal contacting an opposing surface of a volume containing the liquid being measured. However, instances in which ultrasonic spectra including multiple interrogation and response signals are used are also contemplated. The training data may also include one or more corresponding liquid properties, such as viscosity training data 302 or optional temperature training data 303 associated with the ultrasonic spectra. The training data may include values spanning the range of the one or more liquid properties over the range wherein it is desirable to measure the one or more liquid properties.

After the training data is fed into the statistical analysis module, or other appropriate training module, a trained statistical model may be output from the analysis module at 306 that is configured to determine a viscosity, or other appropriate parameter, of a liquid using an ultrasonic spectrum measured from the liquid and one or more other optional types of data including, for example, a temperature of the liquid being analyzed as elaborated on further below. Optionally, the training data may be a chosen subset of a representative data set, and additional data from the representative subset may be used as a validation data set to test the trained statistical model. In some embodiments, such a trained statistical model may be referred to as a trained viscosity statistical model or other appropriate type of trained statistical model if other properties are used to train the model. The trained statistical model may then be stored in an appropriate non-transitory processor readable memory for subsequent recall and/or use at 308. Depending on the particular application, the processor and associated memory used to capture and analyze the ultrasonic spectra may be integrated into a single system. However, embodiments in which sensing and analysis modules are implemented on separate systems using separate processors are also contemplated.

FIG. 6 depicts one non-limiting embodiment of a method 400 of using a trained statistical model to identify the viscosity of a liquid. The illustrated sensing and analysis functionalities may be implemented using any appropriate configuration of one or more processors as described previously above. In the depicted embodiment, an ultrasonic spectrum may be obtained. For instance, the ultrasonic spectrum may be measured for a liquid using any appropriate system including, for example, the systems described above, see 402. As noted previously, in some embodiments, the ultrasonic spectra may be substantially unprocessed. At 404, the ultrasonic spectrum may be provided as an input to a trained statistical model that has been trained for a particular sensor system and type of solution using training data as detailed above. Optionally, additional data such as temperature data may be provided to the trained statistical model as shown at optional step 405, if the trained statistical model was trained to use such additional data. The first trained statistical model may determine an estimate of the viscosity of the liquid using the ultrasonic spectrum, and in some embodiments the optional temperature data, at 406. The determined viscosity may optionally be stored or output as indicated at 408. Additionally, in some embodiments, the viscosity or other parameter determined by another similar model, may be used by one or more processes of a corresponding system controlling one or more processes associated with the liquid being monitored to control operation of those one or more processes associated with the liquid (e.g., temperature, residence/growth time, flow speed, mixing speed, etc.). It should be understood that such control may be implemented using any of the liquid parameters determined using any of the methods and/or systems disclosed herein.

FIG. 7 depicts another non-limiting embodiment of a method 500 which is a variation of the method 400 depicted in FIG. 6 of using a trained statistical model to identify the viscosity of a liquid. The ultrasonic spectrum may be obtained at 502 as previously described with reference to FIG. 6. As noted previously, in some embodiments, the ultrasonic spectrum may be substantially unprocessed. At 504, the ultrasonic spectrum may be provided as an input to a first trained statistical model that has been calibrated for a particular sensor system using training data as detailed above. Optionally, additional data such as temperature data may be provided to the first trained statistical model as shown at optional step 505, if the trained statistical model was trained to use such additional data. The first trained statistical model may be used to determine one or more properties of the liquid at 506 based on the provided ultrasonic spectrum, and optionally based on additional data such as temperature data provided at 505. As discussed above, the first trained statistical model may be used to select a second trained statistical model based in part (or based entirely) on the one or more properties determined by the first trained statistical model at 507. For example, the first trained statistical model may be a trained statistical viscosity model trained to provide an initial estimate of viscosity within a wide viscosity range, and configured to bin the liquid based on whether it is estimated to fall within a low viscosity range, a medium viscosity range, or a high viscosity range each falling within the wide viscosity range. Once the second trained statistical model has been chosen that is associated with the determined range of the initial rough estimate of the desired one or more properties, the ultrasonic spectrum and other optional data of the liquid may be provided to the second trained statistical model at 508 (analogous to 404 in method 400) to determine the desired one or more properties with a greater accuracy. In some embodiments, the viscosity of the liquid is determined using the second trained statistical model at 510 (analogous to 406 of method 400), optionally based on provided temperature data at 509 (analogous to 405 of method 400). The determined viscosity may optionally be stored or output as indicated at 512 (analogous to 408 of method 400). Alternatively, the one or more properties may be used to control one or more process parameters associated with the liquid being monitored.

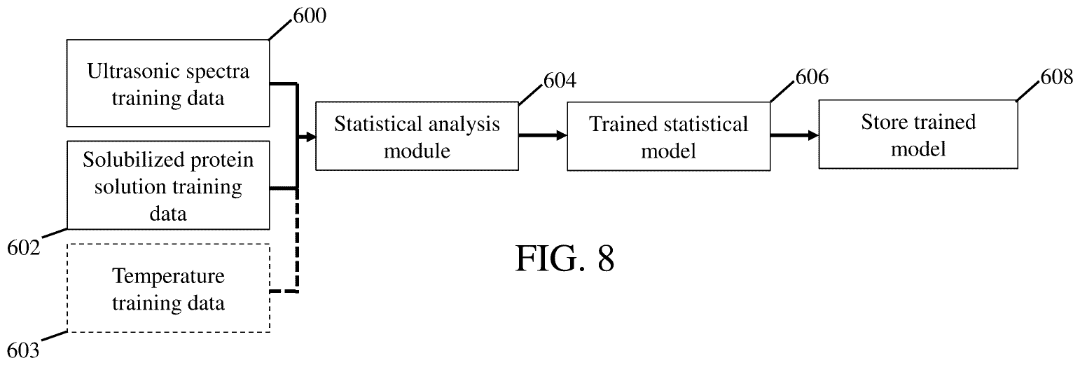

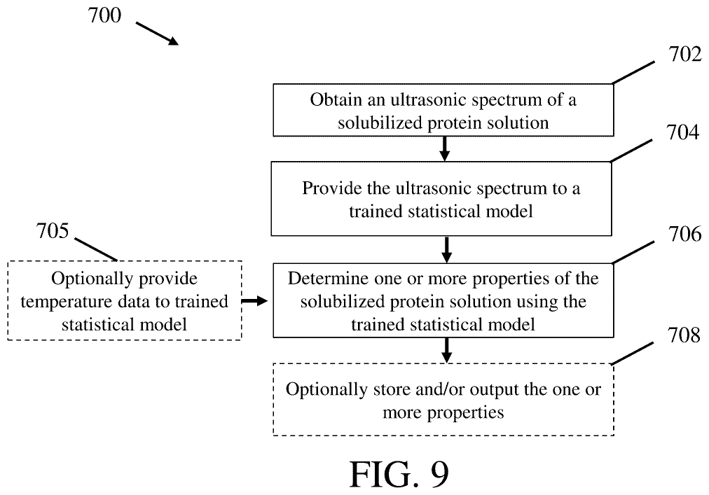

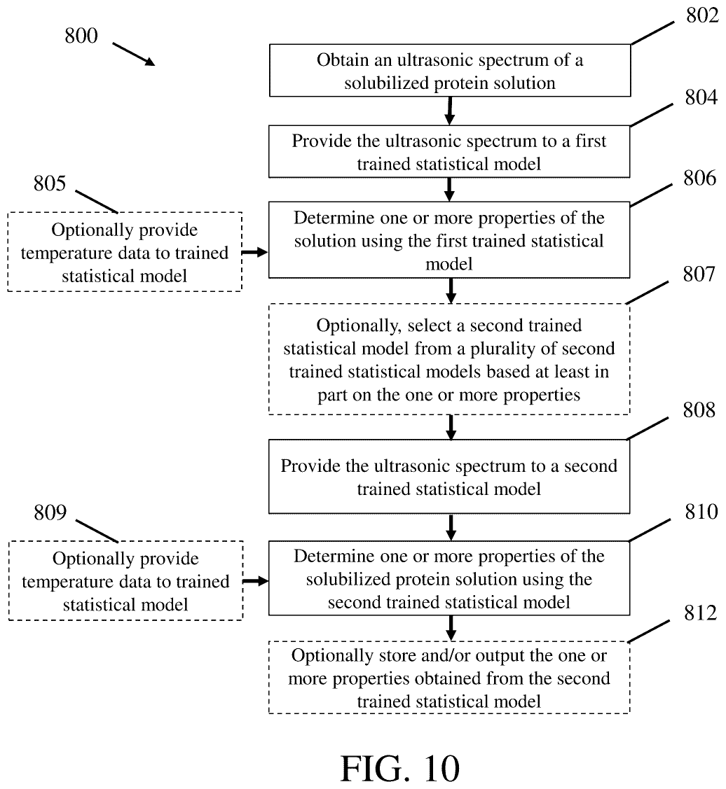

FIG. 8 provides a non-limiting example of training a statistical model for determining properties of a solubilized protein solution. Such a model, once trained, can be used to determine the properties of a solubilized protein solution as discussed in greater detail with reference to FIGS. 9-10 below. The trained statistical model may thus be used in a variety of applications, such as in in-line concentration or viscosity detection systems for solubilized protein solutions. In FIG. 8, training data may be input into an analysis module, such as the depicted statistical analysis module 604. In some embodiments, the training data may correspond to measured ultrasonic spectra training data 600 as disclosed herein. As in FIG. 5, the ultrasonic spectra may correspond to unprocessed ultrasonic spectra that are in the original time domain they were measured in. The measured spectra may include a single ultrasonic interrogation signal and corresponding response signal. The response signal may include both reflected and backscattered ultrasonic signals including a wall response signal corresponding to the interrogation signal contacting an opposing surface of a volume containing the liquid being measured—in the case of method 600, a solubilized protein solution. However, instances in which ultrasonic spectra including multiple interrogation and response signals are used are also contemplated. The training data may also include one or more corresponding solubilized protein solution properties 602 such as solubilized protein concentration data associated with the ultrasonic spectra or optional temperature training data 603. The training data may include values spanning the range of the one or more liquid properties over the range wherein it is desirable to measure the one or more liquid properties. After the training data is fed into the statistical analysis module, or other appropriate training module, a trained statistical model may be output from the analysis module at 606 that is configured to determine one or more properties of a liquid (e.g., a concentration of a solubilized protein if the liquid is a solubilized protein solution) using an ultrasonic spectrum measured from the liquid and one or more other optional types of data including, for example, a temperature of the liquid being analyzed as elaborated on further below. Optionally, the training data may be a chosen subset of a representative data set, and additional data from the representative subset may be used as a validation data set to test the trained statistical model. The trained statistical model may then be stored in an appropriate non-transitory processor readable memory for subsequent recall and/or use at 608. Depending on the particular application, the processor and associated memory used to capture and analyze the ultrasonic spectra may be integrated into a single system. However, embodiments in which sensing and analysis modules are implemented on separate systems using separate processors are also contemplated.

FIG. 9 depicts one non-limiting embodiment of a method 700 of using a trained statistical model to identify one or more properties of a solubilized protein solution. The illustrated sensing and analysis functionalities may be implemented using any appropriate configuration of one or more processors as described previously above. In the depicted embodiment, an ultrasonic spectrum may be obtained. For instance, the ultrasonic spectrum may be measured for a solubilized protein solution using any appropriate system including, for example, the systems described above, see 702. As noted previously, in some embodiments, the ultrasonic spectrum may be substantially unprocessed. At 704, the ultrasonic spectrum may be provided as an input to a trained statistical model that has been calibrated for a particular sensor system using training data as detailed above. Optionally, additional data such as temperature data may be provided to the trained statistical model as shown at optional step 705, if the trained statistical model was trained to use such additional data. The first trained statistical model may determine an estimate of the one or more properties of the solubilized protein solution using the ultrasonic spectrum, at 706. The one or more properties may optionally be stored and/or output as indicated at 708. Alternatively, the one or more properties may be used to control one or more process parameters associated with the liquid being monitored.

FIG. 10 depicts another non-limiting embodiment of a method 800 which is a variation of the method 700 depicted in FIG. 9 of using a trained statistical model to identify one or more properties of a solubilized protein solution. The ultrasonic spectrum may be obtained at 802 as previously described with reference to FIG. 9. As noted previously, in some embodiments, the ultrasonic spectrum may be substantially unprocessed. At 804, the ultrasonic spectrum may be provided as an input to a first trained statistical model that has been calibrated for a particular sensor system using training data as detailed above. Optionally, additional data such as temperature data may be provided to the first trained statistical model as shown at optional step 805, if the trained statistical model was trained to use such additional data. The first trained statistical model may be used to determine an initial estimate of one or more properties of the solubilized protein solution at 806 based on the provided ultrasonic spectrum, and optionally based on additional data such as temperature data provided at 805. As discussed above, the first trained statistical model may be used to select a second trained statistical model from a plurality of second trained statistical models at 807. In particular, the second trained statistical model may be chosen based in part (or based entirely) on the one or more properties of the solubilized protein solution. In some embodiments, a first property of the one or more properties is a concentration of the solubilized protein in the solubilized protein solution. The first trained statistical model may, for example, be a statistical model trained to provide an initial estimate of solubilized protein concentration within a wide concentration range, and configured to bin the concentration as falling within either a low concentration range, a medium concentration range, or a high concentration range each falling within the wide concentration range. Of course, any other trained statistical model described herein could also be used. The one or more properties of the solubilized protein solutions are, in some embodiments, used to select a second trained statistical model from a plurality of second trained statistical models at 807 based, at least in part, on the bin. The plurality of second trained statistical models may include exactly one model for each bin, in some embodiments. Once the second trained statistical model has been chosen the ultrasonic spectrum of the solubilized protein solution may be provided to the second trained statistical model at 808 (analogous to 704 in method 700). In some embodiments, the one or more properties of the solubilized protein solution are determined using the second trained statistical model at 810 (analogous to 706 of method 700), optionally based on provided temperature data at 809 (analogous to 705 of method 700). The determined one or more properties may optionally be stored and/or output as indicated at 812 (analogous to 708 of method 700). Alternatively, the one or more properties may be used to control one or more process parameters associated with the liquid being monitored.

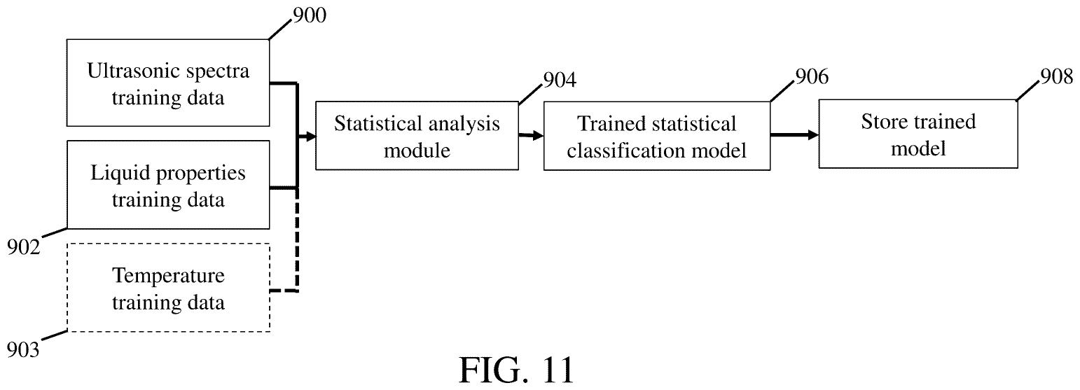

It should, of course, be understood that although FIGS. 5-7 specifically describe viscosity determination using a trained statistical model (a “trained statistical viscosity model”), and FIGS. 8-10 specifically describe the determination of one or more properties of solubilized protein solutions, the training methods and use of trained statistical models described herein are generally suitable for modeling and determining any of the liquid properties described herein (e.g., viscosity, solubilized protein concentration, particle size, particle concentration) for any of a variety of types of liquids (e.g., pure liquids, solutions, or suspensions as described herein), as the disclosure is not so-limited. FIGS. 5-10 generally detail specific implementations that may be particularly useful in the context of in-line systems. Likewise, FIGS. 11-13 below describe models generally suitable for the measurement and property determination of liquids described herein.

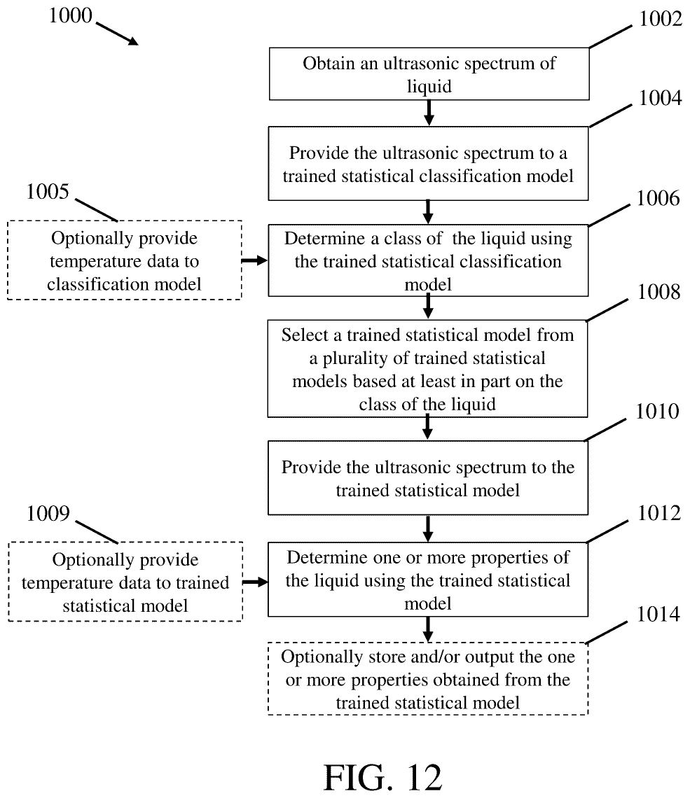

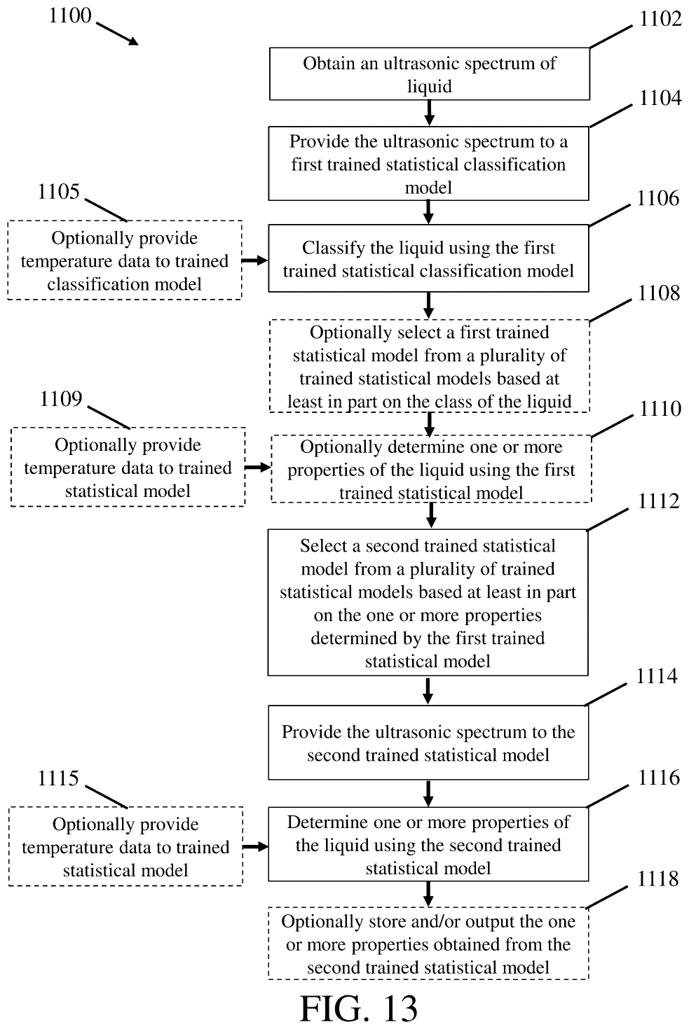

FIG. 11 provides a non-limiting example of training a statistical classification model for classifying a liquid. Such a model, once trained, can be used to classify unknown liquids as discussed in greater detail with reference to FIGS. 12-13 below. In particular, the classification may be used to help select appropriate models for determining the properties of the unknown liquid, as discussed in detail below. The trained statistical classification model may thus be used in a variety of applications, such as in in-line viscosity and concentration detections systems. In FIG. 11, training data may be input into an analysis module, such as the depicted statistical analysis module 904. In some embodiments, the training data may correspond to measured ultrasonic spectra training data 900 as disclosed herein. For example, in one embodiment, the ultrasonic spectra may correspond to unprocessed ultrasonic spectra that are in the original time domain they were measured in. The measured spectra may include a single ultrasonic interrogation signal and corresponding response signal. The response signal may include both reflected and backscattered ultrasonic signals including a wall response signal corresponding to the interrogation signal contacting an opposing surface of a volume containing the liquid being measured. However, instances in which ultrasonic spectra including multiple interrogation and response signals are used are also contemplated. The training data may also include one or more corresponding liquid properties associated with training data 902 or optional temperature training data 903 associated with the ultrasonic spectra. The training data may include liquids having one or more liquid properties within a range over which it might ultimately be desirable to measure the one or more liquid properties.

After the training data is fed into the statistical analysis module, or other appropriate training module, a trained statistical classification model may be output from the analysis module at 906 that is configured to classify a liquid into one of a plurality of classes (e.g., based on the type of liquid, the type of solute, or the type of solvent) using an ultrasonic spectrum measured from the liquid and one or more other optional types of data including, for example, a temperature of the liquid being analyzed as elaborated on further below. Optionally, the training data may be a chosen subset of a representative data set, and additional data from the representative subset may be used as a validation data set to test the trained statistical classification model. In some embodiments, such a trained statistical classification model may be referred to as a trained viscosity statistical model. The trained statistical classification model may then be stored in an appropriate non-transitory processor readable memory for subsequent recall and/or use at 908. Depending on the particular application, the processor and associated memory used to capture and analyze the ultrasonic spectra may be integrated into a single system. However, embodiments in which sensing and analysis modules are implemented on separate systems using separate processors are also contemplated.

FIG. 12 depicts a non-limiting embodiment of a method 1000 of classifying a liquid and using a trained statistical model to identify the one or more properties of the liquid based on the classification. In the depicted embodiment, an ultrasonic spectrum may be obtained. For instance, the ultrasonic spectrum may be measured for a liquid using any appropriate system including, for example, the systems described above, see 1002. As noted previously, in some embodiments, the ultrasonic spectrum may be substantially unprocessed.

At 1004, the ultrasonic spectrum may be provided as an input to a trained statistical classification model that has been calibrated for a particular sensor system and type of solution using training data as detailed above. Optionally, additional data such as temperature data may be provided to the trained statistical classification model as shown at optional step 1005, if the trained statistical classification model was trained to use such additional data. The trained statistical classification model may be used to determine a class of the liquid at 1006 based on the provided ultrasonic spectrum, and optionally based on additional data such as temperature data provided at 1005. As discussed above, the trained statistical classification model may be used to classify the liquid into any of a plurality of classes. For example, the trained statistical classification model may classify the liquid based, at least in part, on whether it is a pure liquid, a solution (e.g., a solubilized protein solution) or a suspension (e.g., of cells or aggregated particles). In some embodiments, the class is based, at least in part, on the identity of a solvent or solute (e.g., solubilized protein).

The determined class of liquid is, in some embodiments, used to select one or more trained statistical models from a plurality of trained statistical models at 1008 based, at least in part, on the class. The plurality of trained statistical models may be configured to determine the one or more desired properties of one class of the plurality of liquid classes that may be identified. For example, in some embodiments, each class of liquid that may be identified by the trained classification statistical model may be associated with one or more separate trained statistical models that are configured to determine the one or more properties of that specific liquid class in some embodiments. Once the one or more trained statistical models for the identified liquid class has been chosen the ultrasonic spectrum of the liquid may be provided to the one or more trained statistical models at 1010. In some embodiments, the one or more trained statistical models is used to determine one or more properties of the liquid at 1012 using any of the methods disclosed herein. The one or more determined properties may optionally be stored or output as indicated at 1014. Alternatively, the one or more properties may be used to control one or more process parameters associated with the liquid being monitored.

FIG. 13 depicts another non-limiting embodiment of a method 1100 which is a variation of the method 1000 depicted in FIG. 12. In the depicted embodiment, an ultrasonic spectrum may be obtained. For instance, the ultrasonic spectrum may be measured for a liquid using any appropriate system including, for example, the systems described above, see 1102. As noted previously, in some embodiments, the ultrasonic spectrum may be substantially unprocessed. At 1104, the ultrasonic spectrum may be provided as an input to a trained statistical classification model that has been calibrated for a particular sensor system and type of solution using training data as detailed above. Optionally, additional data such as temperature data may be provided to the trained statistical classification model as shown at optional step 1105, if the trained statistical classification model was trained to use such additional data. The trained statistical classification model may be used to determine a class of the liquid at 1106 based on the provided ultrasonic spectrum, and optionally based on additional data such as temperature data provided at 1105. As discussed above, the trained statistical classification model may be used to classify the liquid into any of a plurality of classes. The class is optionally used to select a first trained statistical model from a plurality of first trained statistical models at 1108 based, at least in part, on the class. Once the first trained statistical model has been chosen the ultrasonic spectrum of the liquid may optionally be provided to the first trained statistical model to determine an initial estimate of one or more properties of the liquid at 1110. Optionally based temperature data may also be provided to the first trained statistical model at 1109. In some embodiments, the first trained statistical model is used to select a second trained statistical model from among a plurality of second trained statistical models configured to determine the one or more desired properties at 1112, as previously described. The ultrasonic spectrum of the liquid may be optionally provided to the second trained statistical model at 1114, optionally along with temperature data provided at 1115. The second trained statistical model may then be used to determine one or more properties of the liquid at 1116. As noted above previously, the one or more properties determined with the selected second trained statistical model may be the same or different than the property determined with the first trained statistical model and/or the second trained statistical model may exhibit a greater accuracy than the initial estimate determined by the first trained statistical model. In either case, the one or more determined properties may optionally be stored or output as indicated at 1118, as shown. Alternatively, the one or more properties may be used to control one or more process parameters associated with the liquid being monitored.

It should be understood that any of the above described methods and/or systems may be implemented using one or more controllers including at least one processor operatively coupled to the various controllable portions of an system as disclosed herein. The method may be embodied as computer readable instructions stored on non-transitory computer readable memory associated with the at least one processor such that when executed by the at least one processor the corresponding system may perform any of the actions and/or processes related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

### Example 1

In this example, trained statistical models were developed to describe the viscosities and concentrations of four non-limiting solubilized protein solutions—mAb1 (a Humeira® Biosimilar); Lysozyme; mAb2 (a Xolair Biosimilar); and bovine serum albumin (BSA). Representative data were prepared by measuring ultrasonic spectra, viscosities, and concentrations for various aqueous solutions of each protein at a temperature of 23° C. The statistical model for determining the viscosity and the statistical model for determining the concentration of each solubilized protein solution were each trained by randomly selecting and using 80% of the representative data as training data, and by using the remaining 20% of the data to validate the trained model. The statistical model used to fit each data set was the Orthogonal Partial Least-Squares (OPLS) model.

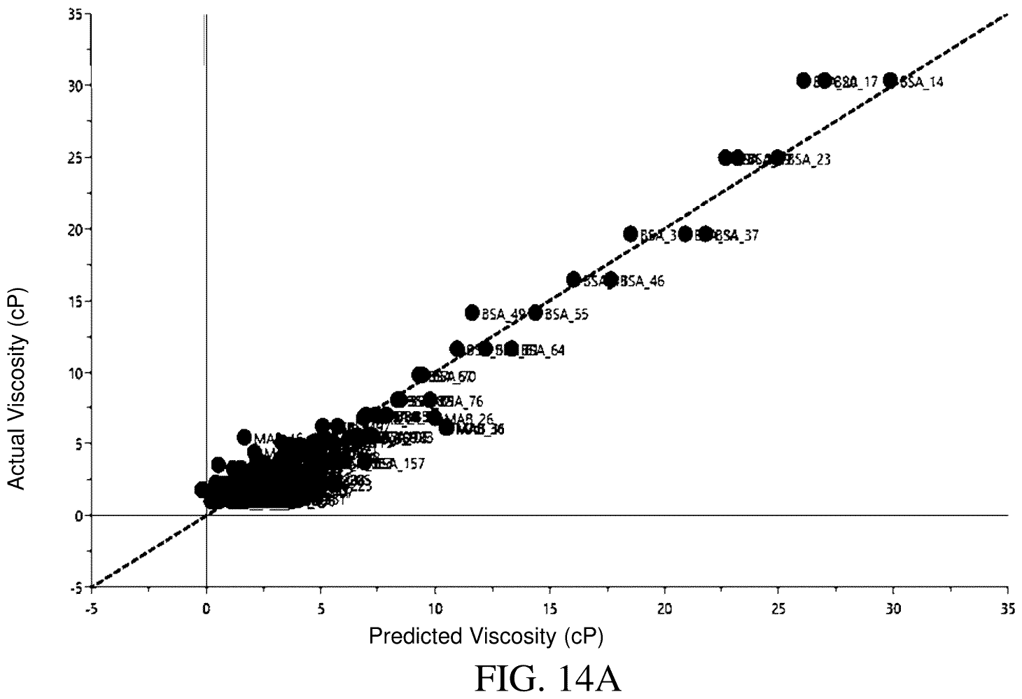

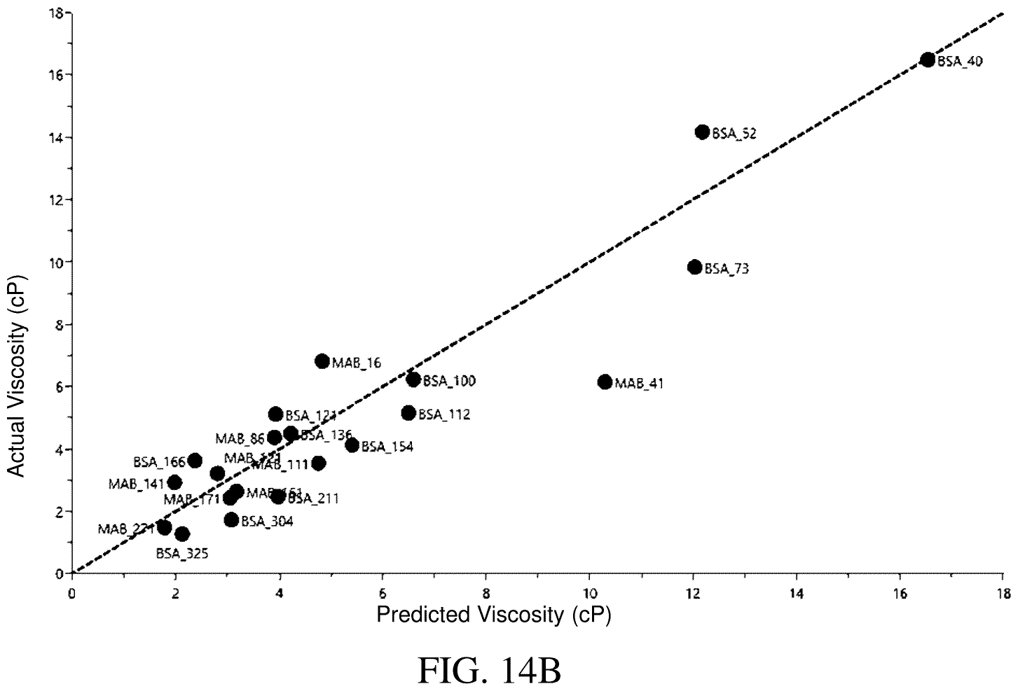

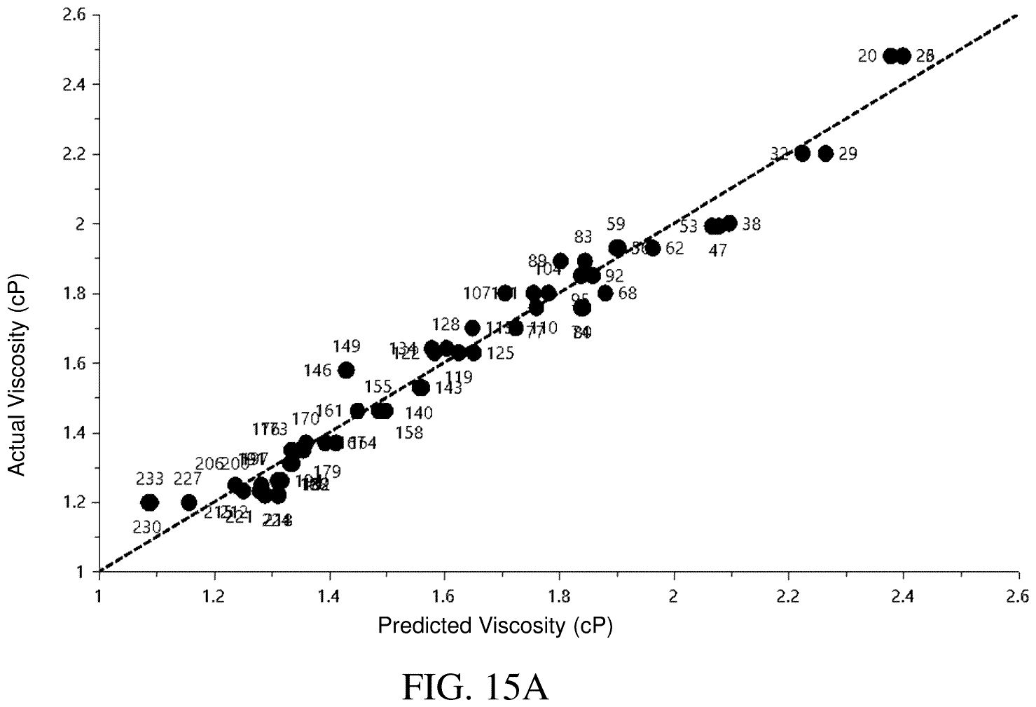

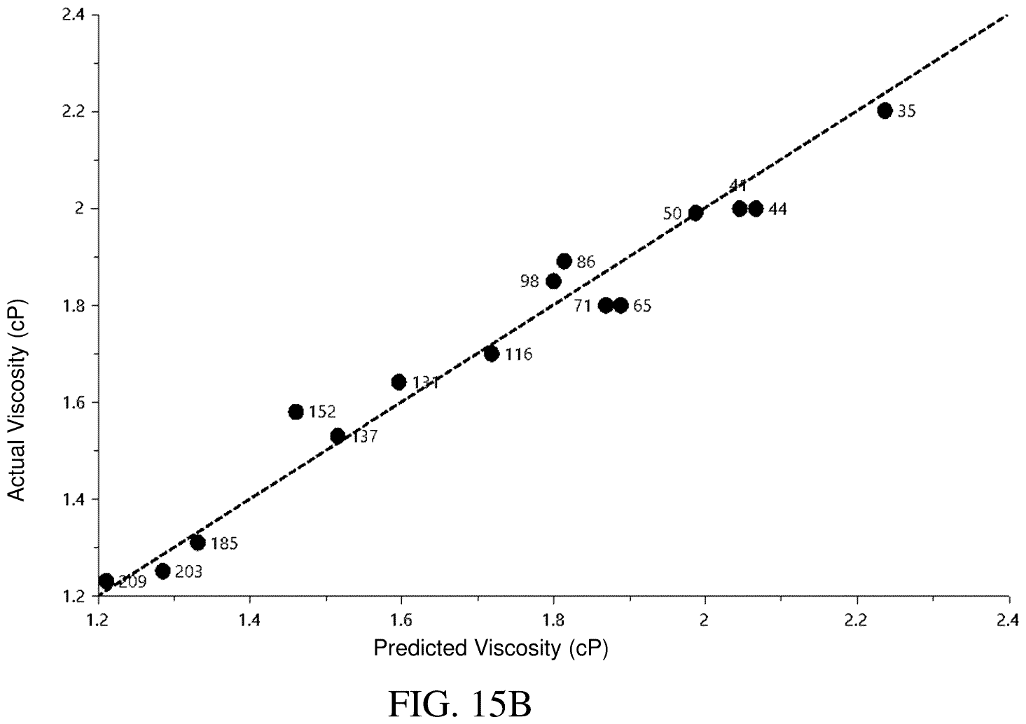

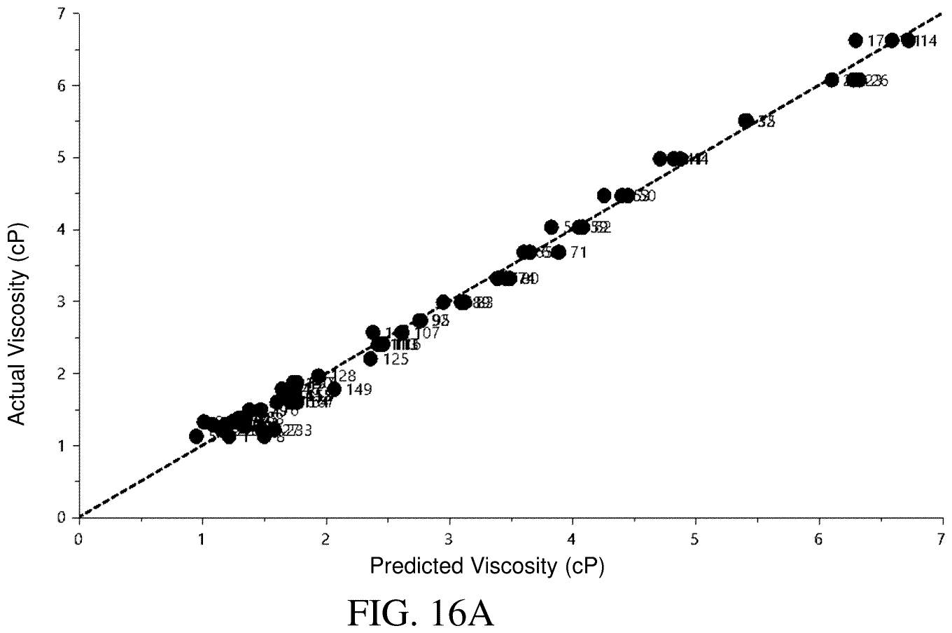

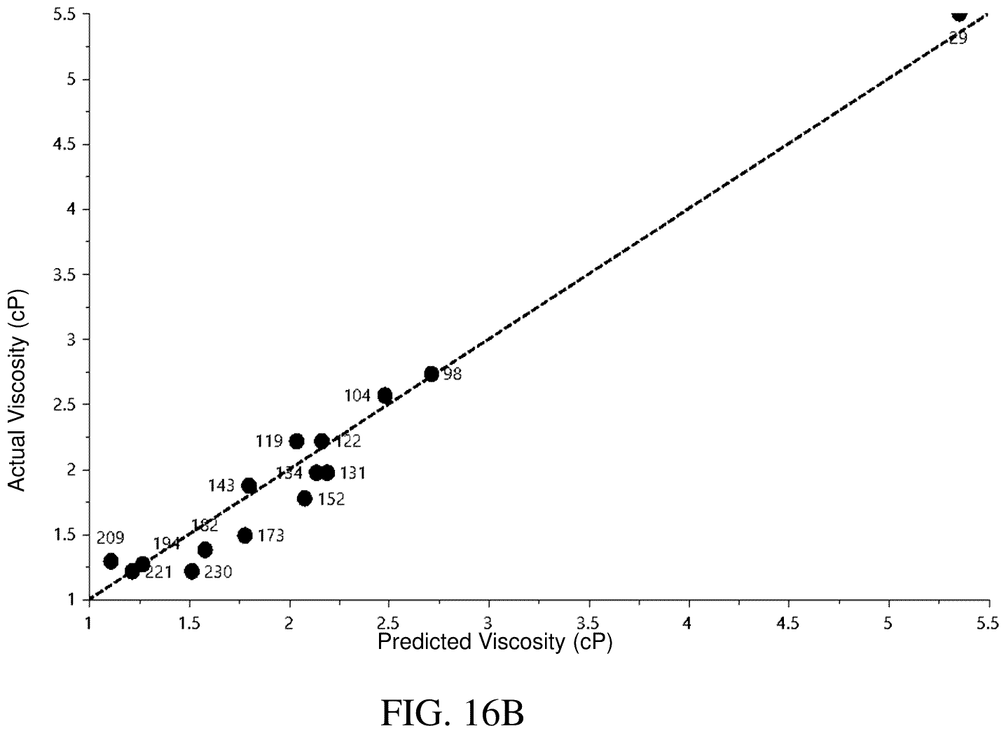

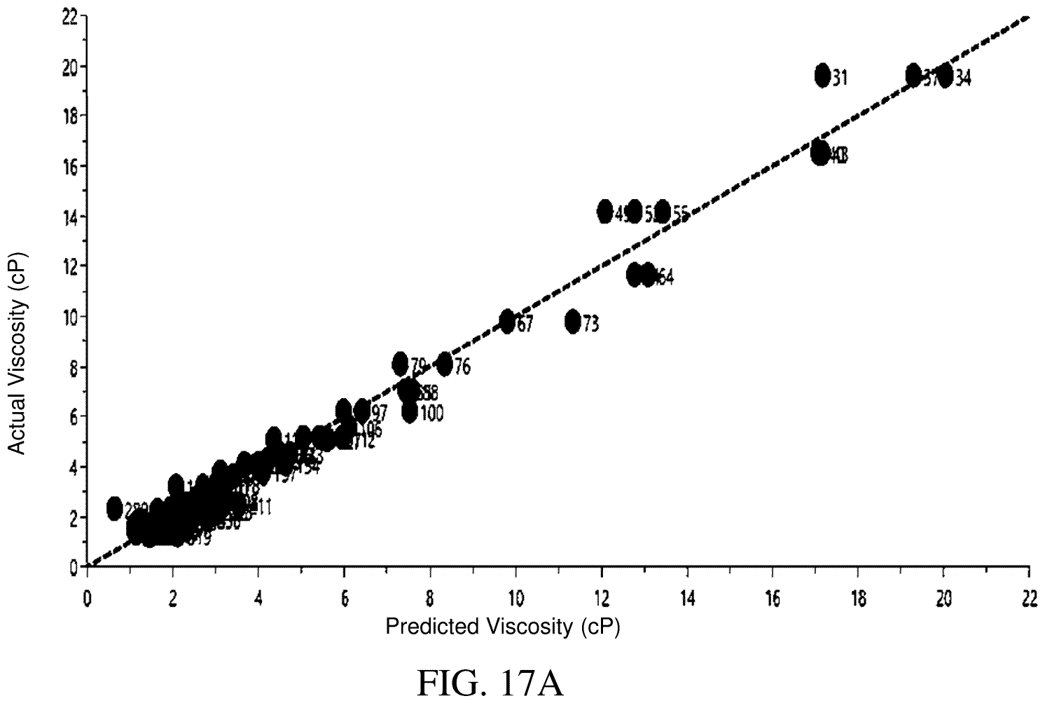

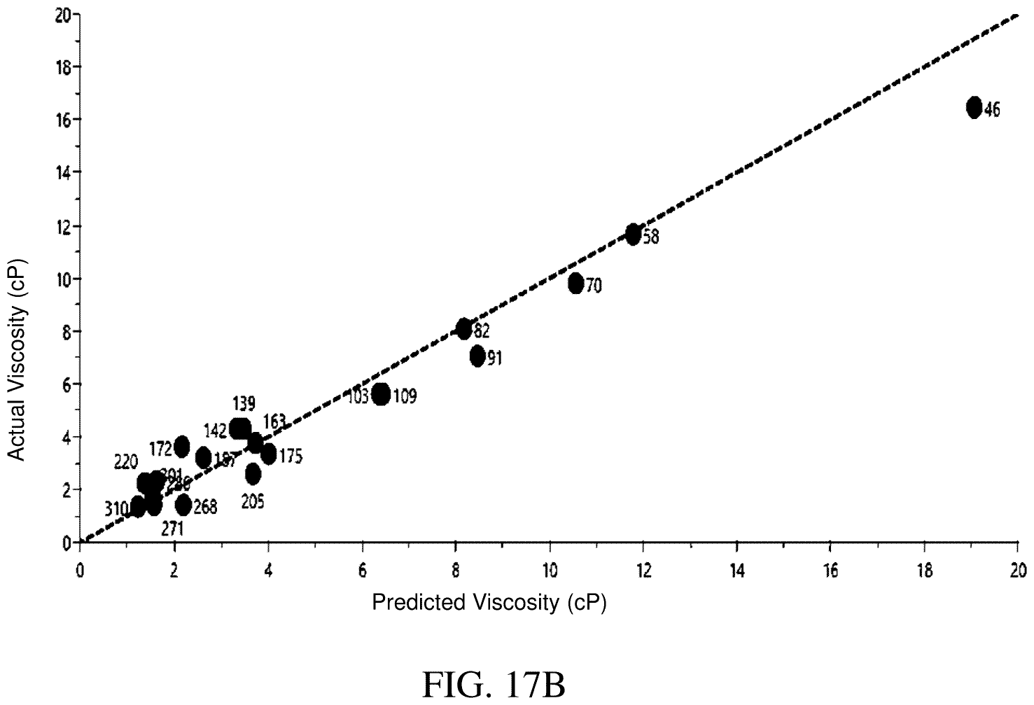

FIGS. 14A-17B compare the actual viscosity values and the predicted viscosity values of the training data and the validation data for each protein in order to illustrate the accuracy of the model—a perfectly predictive model would result in perfect alignment of the data along the dashed y=x line shown in each figure. FIGS. 14A and 14B show the training data (FIG. 14A) and the validation data (FIG. 14B) for the viscosity of mAb1. FIGS. 15A and 15B show the training data (FIG. 15A) and the validation data (FIG. 15B) for the viscosity of lysozyme. FIGS. 16A and 16B show the training data (FIG. 16A) and the validation data (FIG. 16B) for the viscosity of mAb2. And FIGS. 17A and 17B show the training data (FIG. 17A) and the validation data (FIG. 17B) for the viscosity of BSA. As shown in FIGS. 14A-17B, the trained statistical model for each protein could accurately characterize the viscosity of the protein over a wide range of viscosity values ranging between 0 and 20 cP. Table 1 presents the R² values associated with the training data and the Q² values associated with the validation data presented in FIGS. 14A-17B. As shown in Table 1, the R² values were very close to 1, indicating high correlation between predicted and actual viscosities. The relatively small difference between the R² and the Q² values of the validation data indicate that the accuracy of the trained statistical models is likely not a result of overfitting, since the model accurately characterizes the validation data, not just the training data.

TABLE 1
Model R² and Q² values associated viscosity and
concentration modeling presented in FIGS. 14A-21B.

| | Viscosity | | Concentration | |
|---|---|---|---|---|
| | Training | Validation | Training | Validation |
| Protein | R² | Q² | R² | Q² |
| mAbl | 0.95 | 0.92 | 0.83 | 0.76 |
| Lysozyme | 0.98 | 0.96 | 0.96 | 0.98 |
| Mab2 | 0.98 | 0.96 | 0.98 | 0.94 |
| BSA | 0.98 | 0.92 | 0.98 | 0.97 |

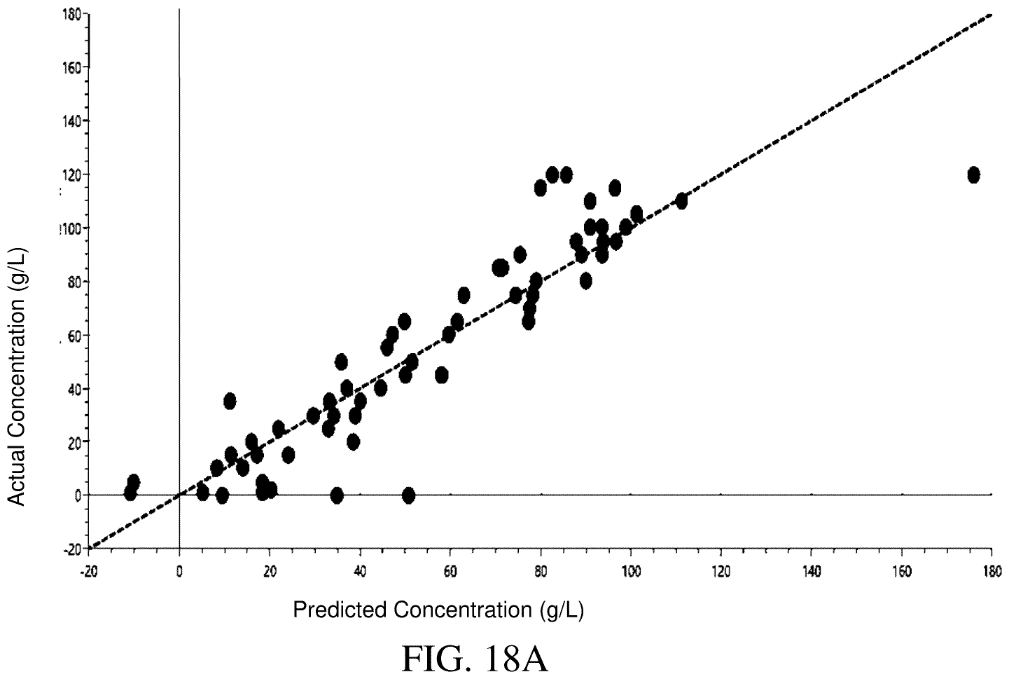

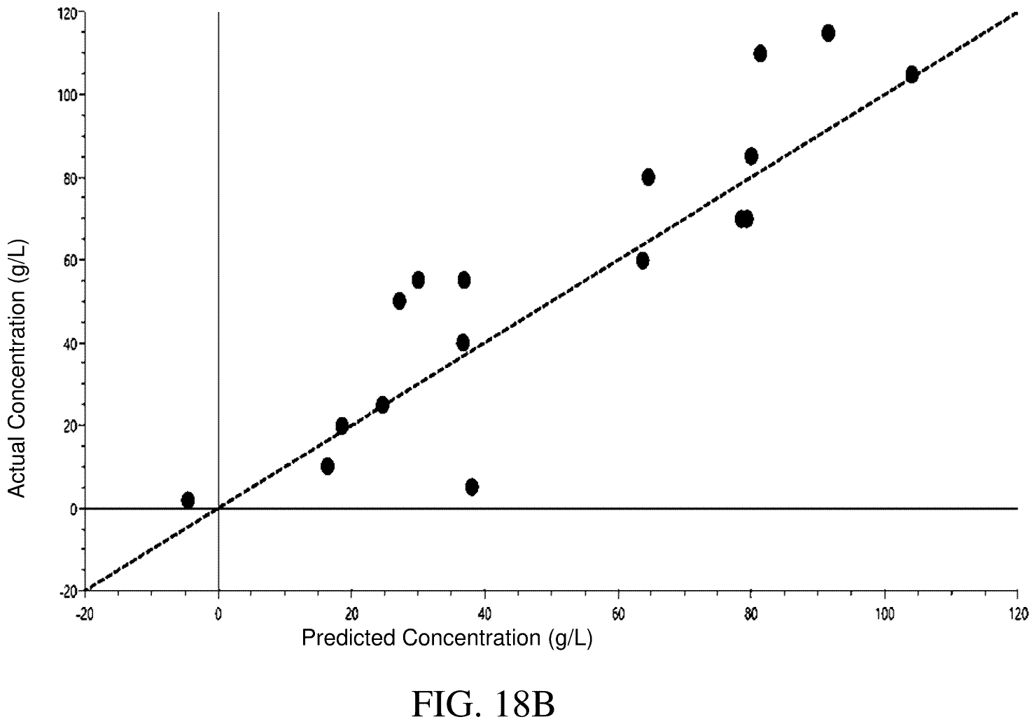

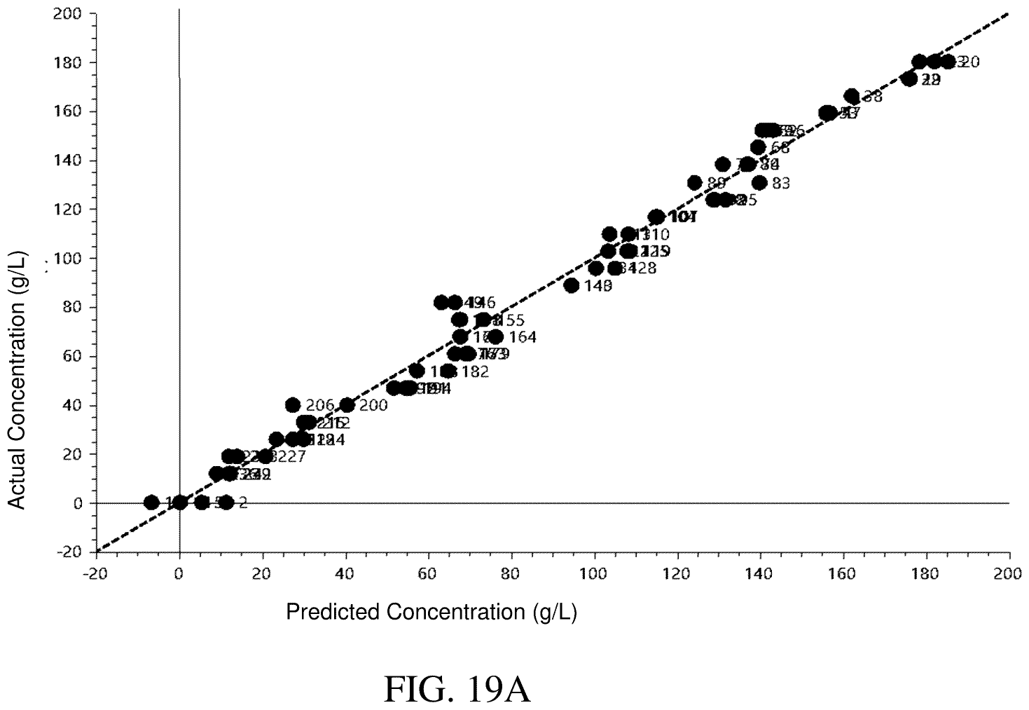

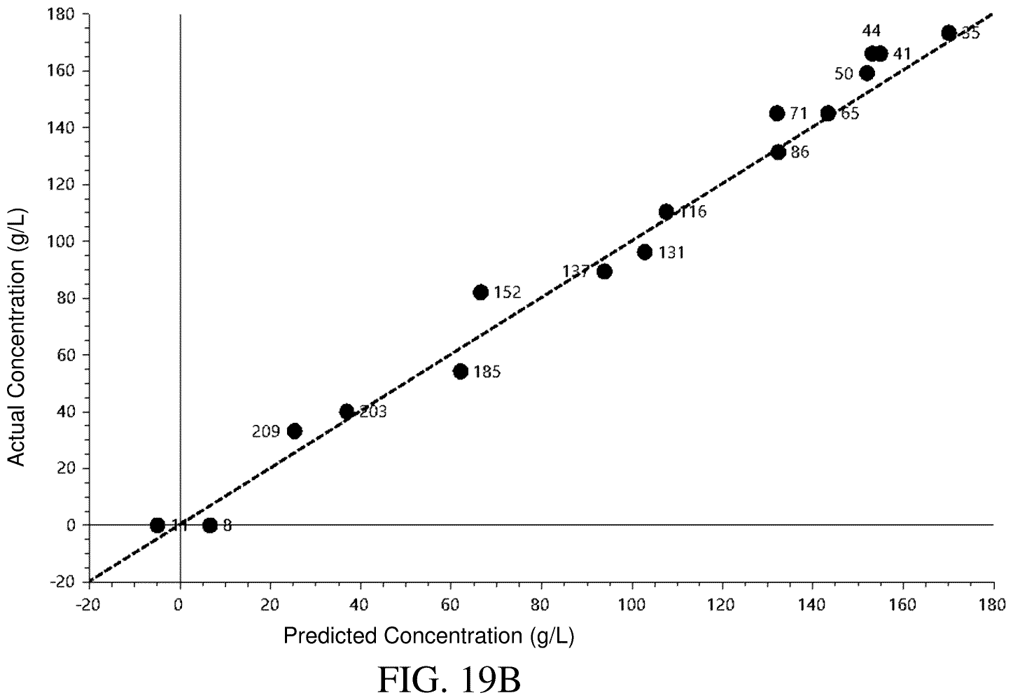

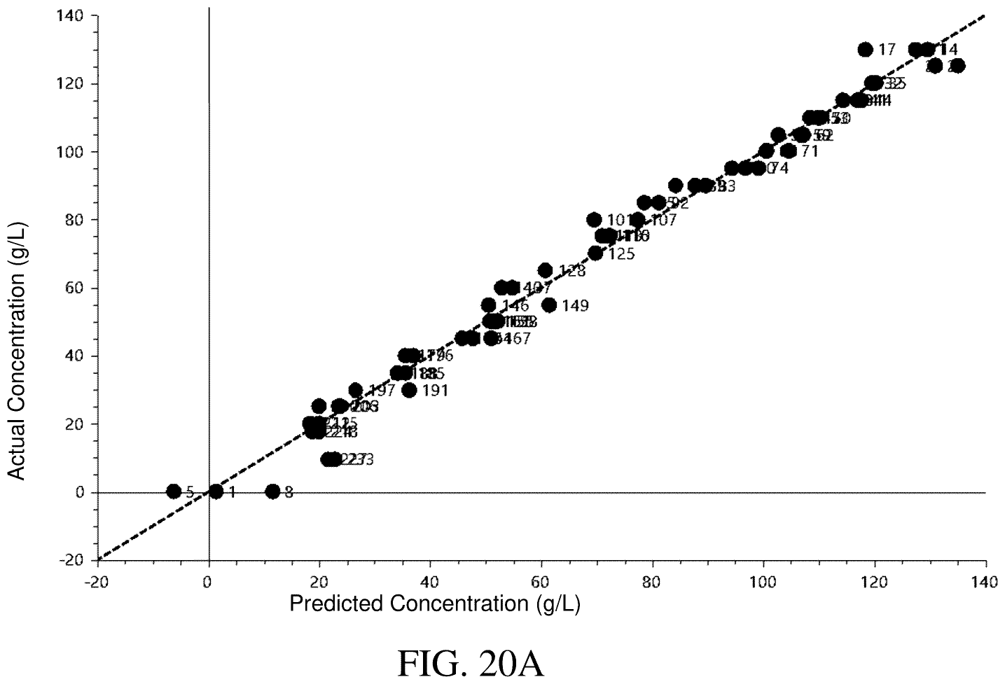

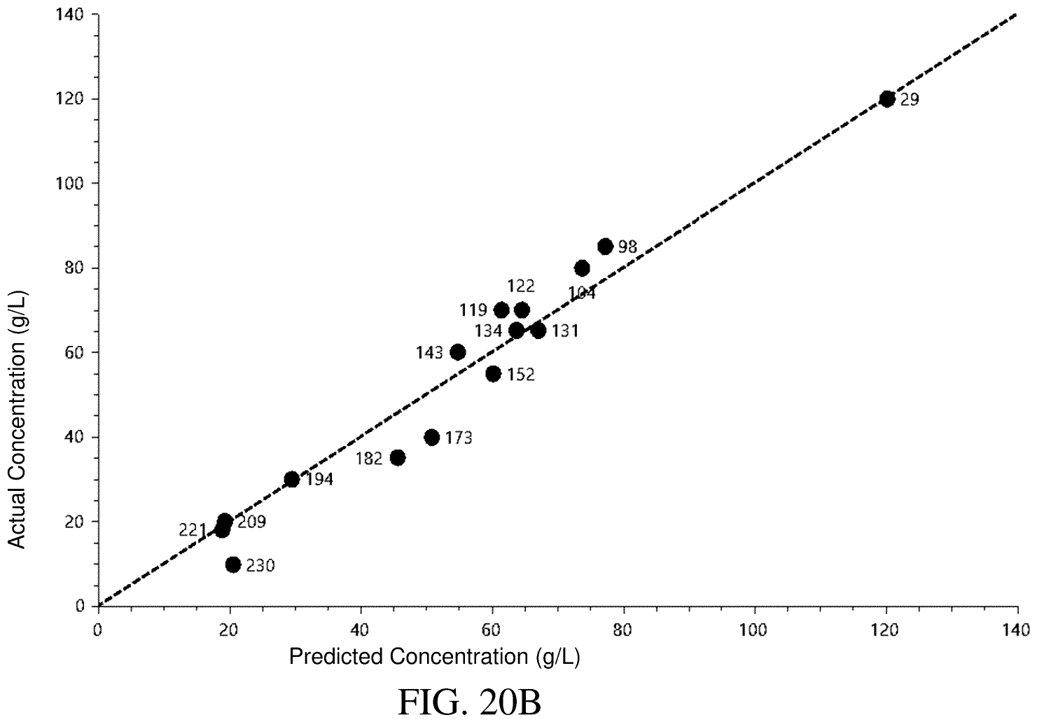

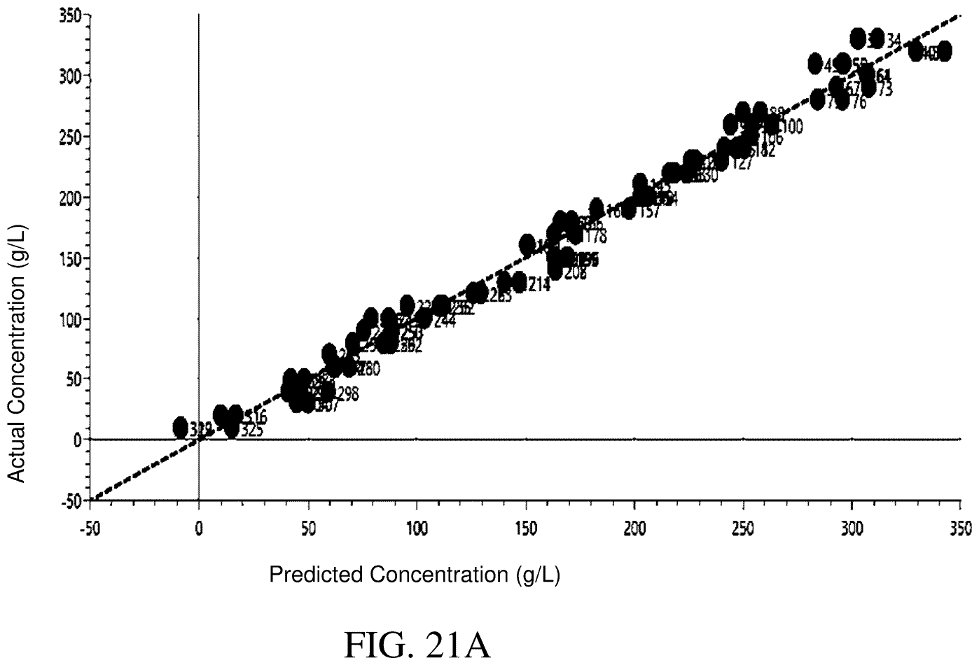

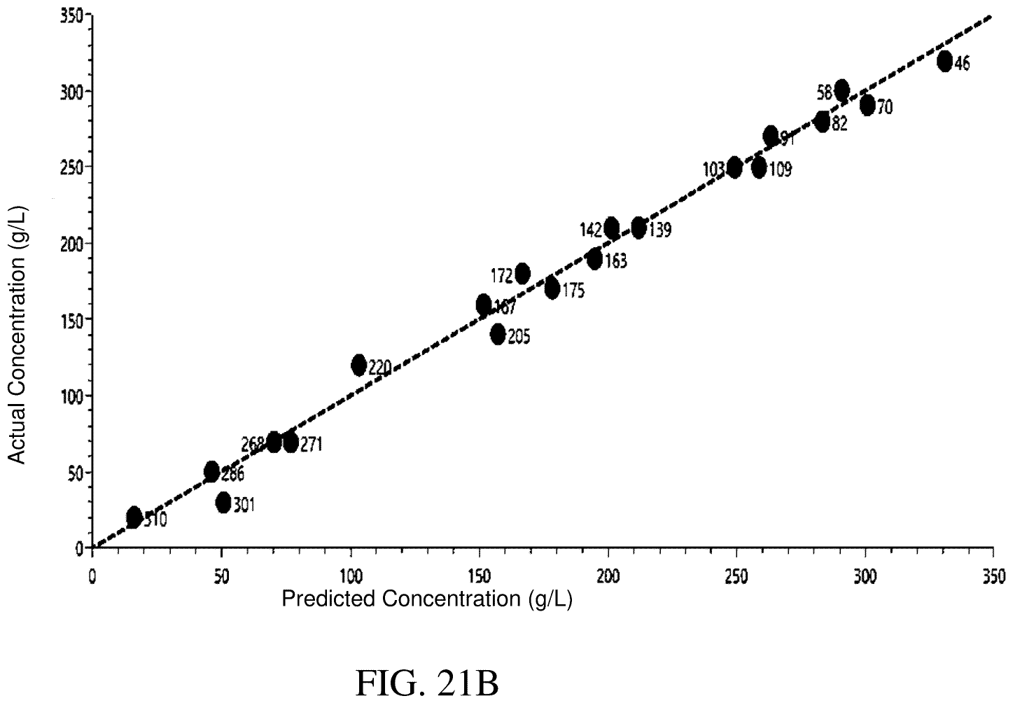

FIGS. 18A-21B compare the actual solubilized protein concentration values and the predicted solubilized protein concentration values of the training data and the validation data for each protein in order to illustrate the accuracy of the model—a perfectly predictive model would result in perfect alignment of the data along the dashed y=x line shown in each figure. FIGS. 18A and 18B show the training data (FIG. 18A) and the validation data (FIG. 18B) for the concentration of mAb1. FIGS. 19A and 19B show the training data (FIG. 19A) and the validation data (FIG. 19B) for the concentration of lysozyme. FIGS. 20A and 20B show the training data (FIG. 20A) and the validation data (FIG. 20B) for the concentration of mAb2. And FIGS. 21A and 21B show the training data (FIG. 21A) and the validation data (FIG. 21B) for the concentration of BSA. As shown in FIGS. 18A-21B, the trained statistical model for each protein could accurately characterize the concentration of the protein over a wide range of concentration values ranging between 0 and 350 g/L. Table 1 presents the R² values associated with the training data and the Q² values associated with the validation data presented in FIGS. 18A-21B. As shown in Table 1, the R² values were relatively close to 1, indicating high correlation between predicted and actual concentration. The relatively small difference between the R² and the Q² values of the validation data indicate that the accuracy of the trained statistical models is likely not a result of overfitting, since the model accurately characterizes the validation data, not just the training data.

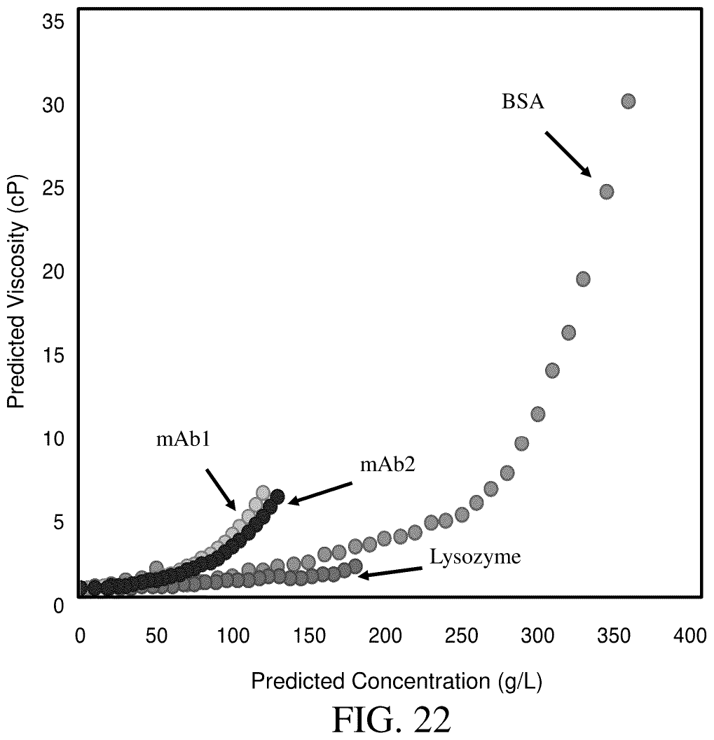

FIG. 22 compares the predicted viscosity with the predicted concentration for each protein, illustrating that, as expected, although viscosity is strongly concentration dependent, the viscosity of solubilized protein solutions depends to a significant extent on the individual proteins involved. This results highlights why independent modeling of both viscosity and solubilized protein concentration may be necessary for accurate modeling of protein solutions using ultrasonic spectra-it would be impossible to interchange viscosity measurements for concentration measurements, in most cases.

This example demonstrates that the trained statistical models of the type provided herein may be used to accurately model the viscosity of various liquids, and to accurately model the concentration of various solubilized proteins in solubilized protein solutions.

### Example 2

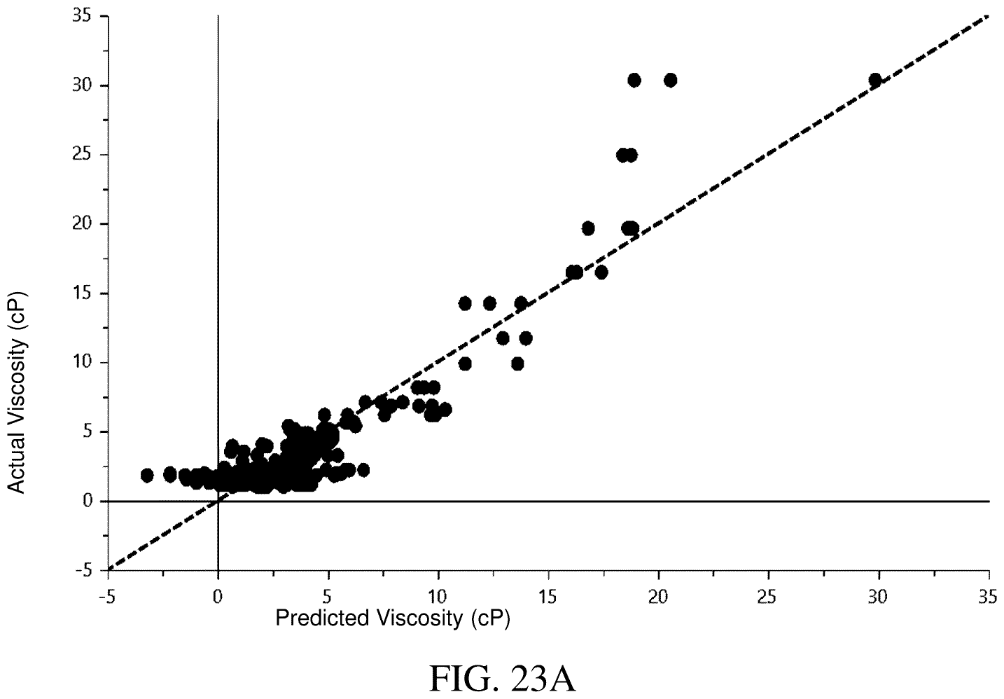

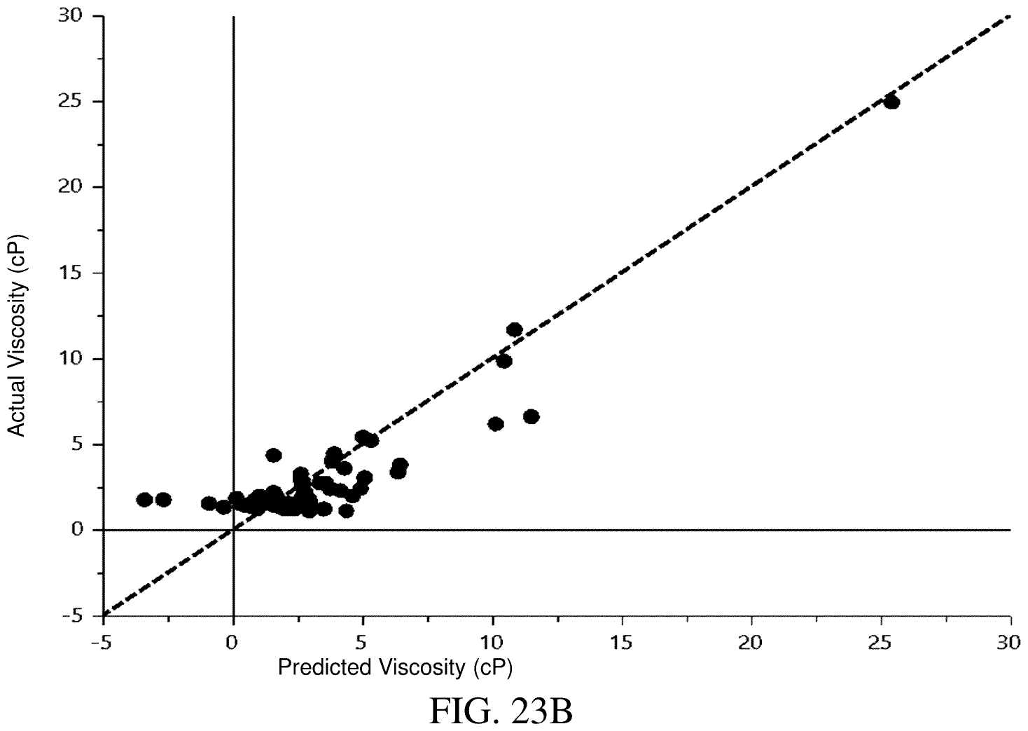

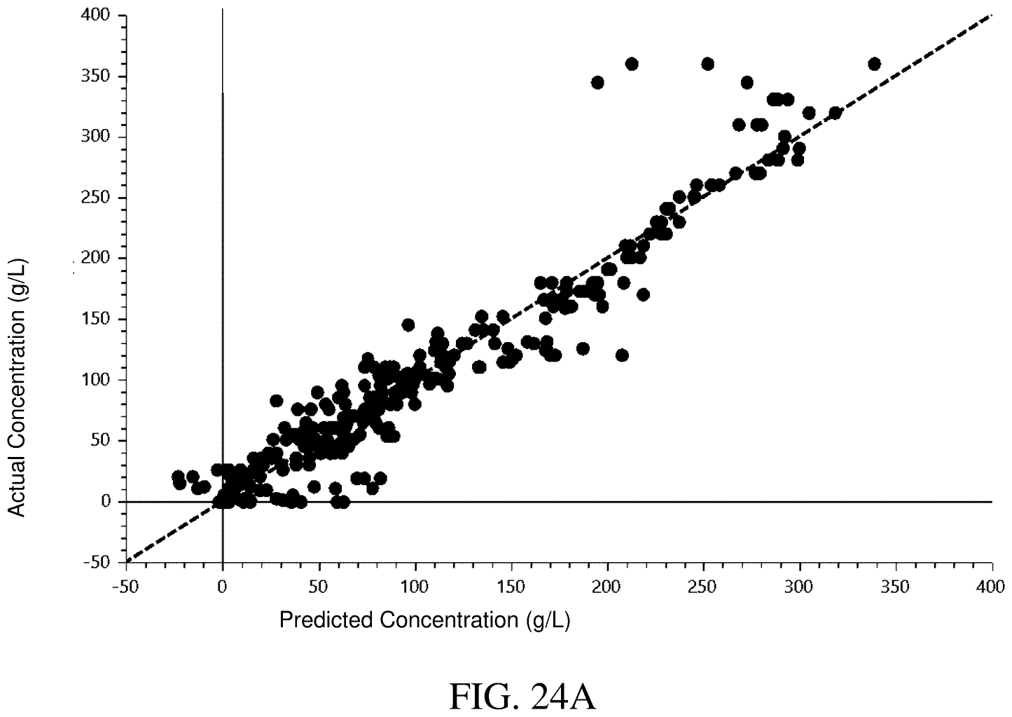

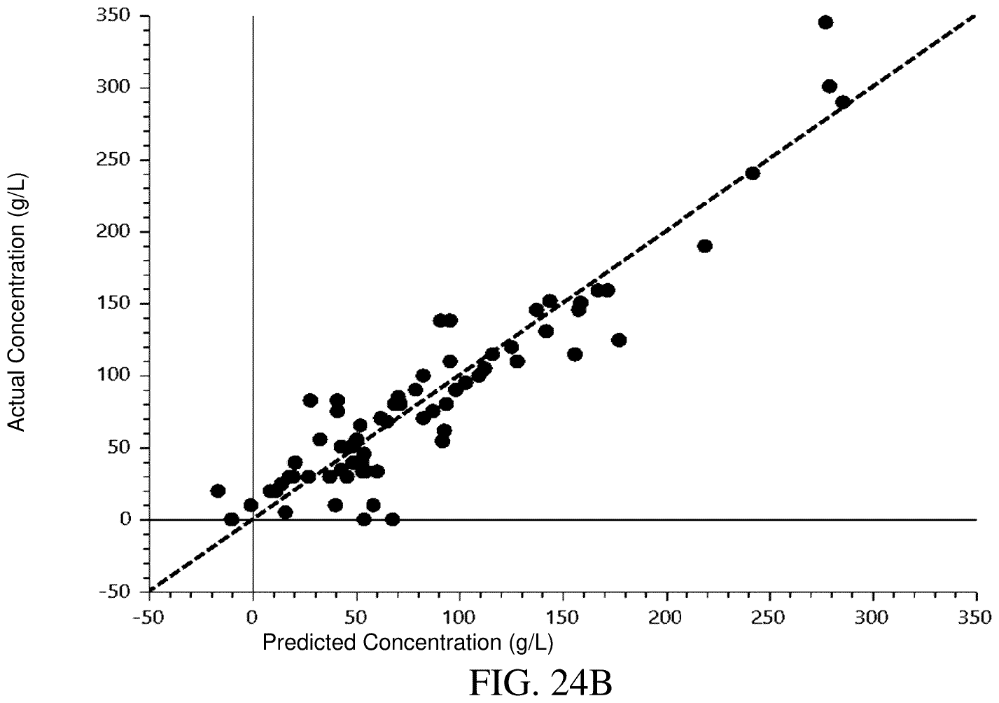

This example describes the training and use of a trained statistical classification model for classifying an unknown protein solution in order to identify the unknown protein. In this example, the representative viscosity data for all proteins described in Example 1 were aggregated to form a single aggregated viscosity data set and the representative solubilized protein concentration data for all proteins described in Example 1 were aggregated to form a single aggregated protein concentration data set. As in example 1, the data of each representative data set were randomly assigned to a training data set comprising 80% of the data or to a validation data set containing 20% of the data. An OPLS model was then trained to predict viscosity of an unknown protein solution using the viscosity training data and an OPLS model was trained to predict the solubilized protein concentration of an unknown protein solution using the concentration training data. FIGS. 23A and 23B show the training data (FIG. 23A) and the validation data (FIG. 23B) for the viscosity of the unknown protein. The training data had an R² value of 0.85 and the validation data had a Q² of 0.78, indicating that the model was a somewhat accurate but not completely accurate predictor of viscosity. FIGS. 24A and 24B show the training data (FIG. 24A) and the validation data (FIG. 24B) for the concentration of the unknown solubilized protein. The training data had an R² value of 0.91 and the validation data had a Q² of 0.81, indicating that the model was a reasonably good predictor of protein concentration, even of an unknown protein. These models were notably less accurate than the models trained on solubilized protein solutions of specific, known proteins, described above.

A trained statistical classification model was then used to classify a liquid by identifying the unknown protein as either mAb1, Lysozyme, mAb2, or BSA using the ultrasonic spectrum. The model was a partial least squares discriminant analysis (PLS-DA) model trained data. The trained statistical classification model was able to accurately characterize 100% of BSA solutions, 100% of mAb1 solutions, 96% of Lysozyme solutions and 100% of mAb2 solutions. Once the proteins were correctly classified, the higher-accuracy models previously described could be used to determine the viscosity and/or protein concentration of the solubilized protein solutions with improved accuracy, relative to the accuracy of the determinations of the generic model whose results were represented in FIGS. 23A-24B

This example demonstrates the improvement in accuracy that can result from classification of solubilized protein solutions using a model trained to classify unknown solubilized protein solutions. Once an unknown solution has been classified using this model to identify the solubilized protein it contains, one of the high-accuracy, protein-specific models of Example 1 could be chosen based on the identity of the protein, and used to accurately determine the viscosity and solubilized protein concentration of the liquid.

### Example 3

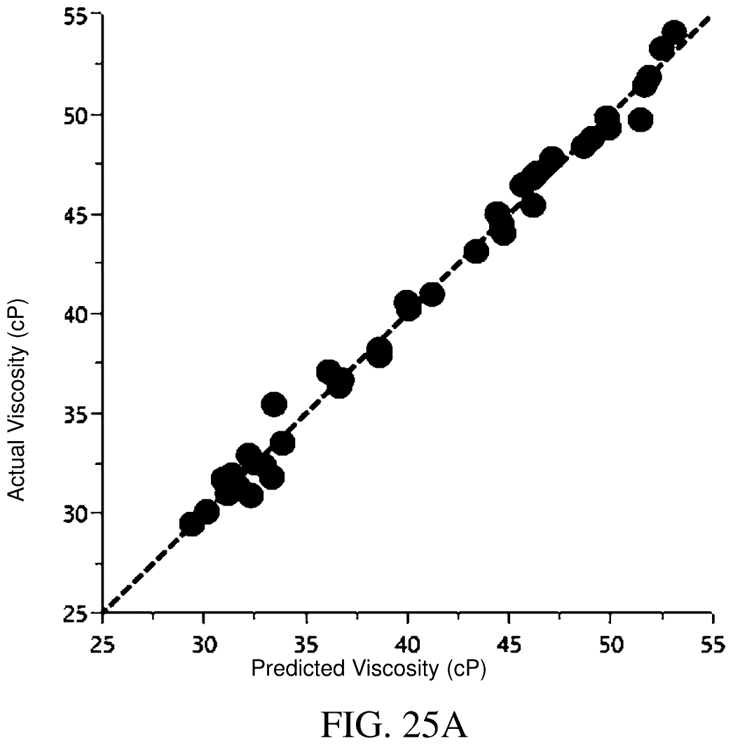

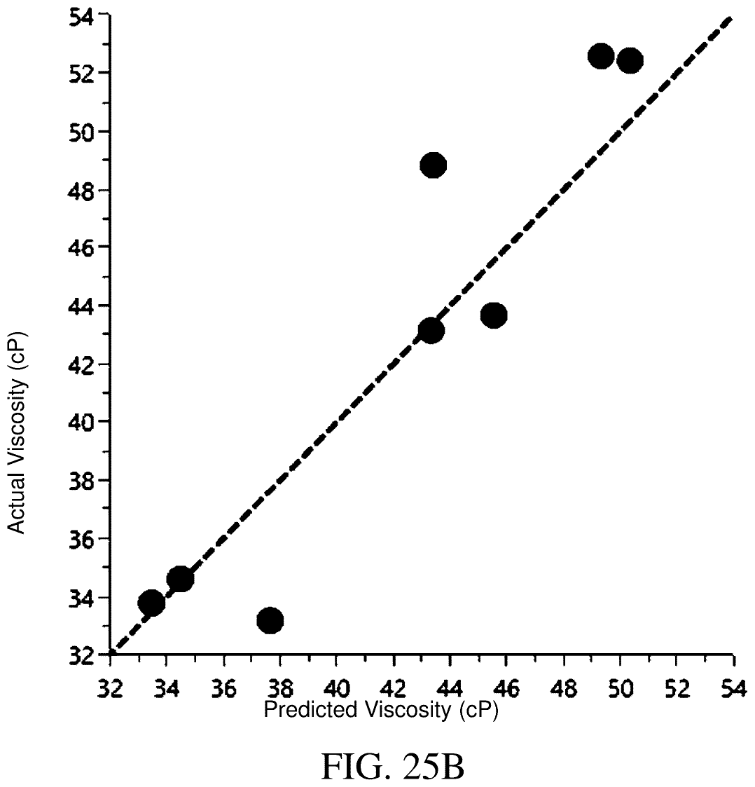

This example describes the training and use of a trained statistical model for determining the viscosity of liquid measured at various temperatures. The statistical model was trained by varying the temperature of an 80% glycerin solution over a range of about 10 degrees in order to vary the viscosity of the solution between 30 and 50 cP. An OPLS model was then trained to predict viscosity of the solution using the viscosity training data. FIGS. 25A and 25B show the training data (FIG. 25A) and the validation data (FIG. 25B) for the viscosity of the 80% glycerin solution. As shown in the figures, the model described both the training and the validation data with high accuracy. This example, demonstrates that the model is characterizing viscosity, rather than simply capturing a change in the composition of the solution, since the temperature variation changed the viscosity without affecting the composition of the solution. The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1. A method for characterizing the viscosity of a liquid, the method comprising:
obtaining an ultrasonic spectrum of the liquid;
providing the ultrasonic spectrum to a trained viscosity statistical model of the liquid; and
determining the viscosity of the liquid using the trained viscosity statistical model.

2. The method of claim 1, further comprising:
providing the ultrasonic spectrum to a first trained statistical model;
determining one or more properties of the liquid using the first trained statistical model; and
selecting the trained viscosity statistical model from a plurality of trained statistical viscosity models based at least in part on the determined one or more properties,
wherein a first of property of the one or more properties determined by the first trained statistical model is the viscosity of the liquid.

3-4. (canceled)

5. The method of claim 2, wherein the first of property of the one or more properties determined by the first trained statistical model is the viscosity of the liquid and the one or more properties determined by the first trained statistical model further include a second property of the liquid that is different from the viscosity of the liquid,
wherein the second property is a concentration.

6-8. (canceled)

9. The method of claim 5, further comprising controlling one or more operations of a system in which the liquid is disposed based at least in part on the determined viscosity.

10. The method of claim 1, further comprising agitating the liquid.

11. The method of claim 1, wherein the trained viscosity statistical model is a multivariant model, a neural network, a partial least squares regression model, a random forest regression model, or a support vector machine regression.

12-13. (canceled)

14. A method for characterizing one or more properties of a solubilized protein solution, the method comprising:
obtaining an ultrasonic spectrum of the solubilized protein solution;
providing the ultrasonic spectrum to a trained statistical model of the solution; and
determining the one or more properties of solubilized protein solution using the trained statistical model.

15. The method of claim 14, wherein a first property of the one or more properties is the concentration of the solubilized protein in the solubilized protein solution.

16. The method of claim 14, wherein:
the trained statistical model is a second trained statistical model of the solution, and
the method further comprises:
determining one or more properties of the solubilized protein solution using a first trained statistical model; and
selecting the second trained statistical model based at least in part on value of the one or more properties determined by the first trained statistical model.

17. The method of claim 16, wherein a first property of the one or more properties determined by the first trained statistical model is the concentration of the solubilized protein in the solubilized protein solution.

18-21. (canceled)

22. The method of claim 14, further comprising controlling one or more operations of a system in which the liquid is disposed based on the determined one or more properties of the solubilized protein solution.

23. The method of claim 14, further comprising agitating the solubilized protein solution during sensing.

24. The method of claim 14, wherein the trained statistical model is a multivariant model, a neural network, a partial least squares regression model, a random forest regression model, or a support vector machine regression.

25-27. (canceled)

28. A method for characterizing a liquid, the method comprising:
obtaining an ultrasonic spectrum of the liquid;
providing the ultrasonic spectrum to a first trained statistical classification model; and
classifying the solution using the first trained statistical model to determine a class of the liquid from a plurality of classes.

29. The method of claim 28, further comprising:
selecting a second trained statistical model based at least in part on the class of the liquid as determined by the first trained statistical model;
providing the ultrasonic spectrum to the second trained statistical model; and
determining one or more properties of the liquid using the second trained statistical model.

30. The method of claim 28, wherein the trained statistical classification model classifies the liquid based at least in part on: the identity of a solute or solvent of the liquid; the identity of a protein; and/or whether the liquid is a pure liquid, a solution, or a suspension.

31-33. (canceled)

34. The method of claim 28, wherein the trained statistical classification model is selected from the group of a principal component analysis (PCA) model, an orthogonal projections to latent structures discriminant analysis (OPLS-DA) model, a partial least squares discriminant analysis (PLS-DA) model, a K-nearest neighbors (KNN) model, a logistic regression model, a support vector machine classification (SVMC) model, a random forest analysis model, and a neural network model.

35-37. (canceled)

38. The method of claim 1, wherein obtaining the ultrasonic spectrum includes:
emitting an ultrasonic interrogation signal into the liquid or solubilized protein solution; and
sensing the resulting ultrasonic spectrum.

39. (canceled)

40. The method of claim 1, wherein the ultrasonic spectrum is an unprocessed ultrasonic spectrum.

41. An ultrasonic sensor system comprising:
a processor configured to perform the method of claim 1 to characterize the liquid or the solubilized protein solution,
wherein the processor is operatively coupled to an ultrasonic transducer configured to emit an ultrasonic interrogation signal into the liquid or the solubilized protein solution, wherein the ultrasonic transducer is configured to sense a resulting ultrasonic spectrum; and
wherein the processor is configured to perform the obtaining the ultrasonic spectrum by receiving the ultrasonic spectrum with the ultrasonic transducer.

42-57. (canceled)
